(19) United States
(12) Patent Application Publication
(10) Pub. No.: US 2016/0256889 A1
(43) Pub. Date: Sep. 8, 2016

(54) VARIABLE OUTPUT DISPENSING APPLICATOR AND ASSOCIATED METHODS OF DISPENSING

(71) Applicant: Nordson Corporation, Westlake, OH (US)

(72) Inventor: Kenneth Jones, Cumming, GA (US)

(21) Appl. No.: 14/640,776

(22) Filed: Mar. 6, 2015

(51) Int. Cl. B05C 5/02; B05C 11/10

(52) U.S. Cl. CPC B05C 5/0225; B05C 11/1039

(57) ABSTRACT

A variable output dispensing applicator is configured to dispense patterns of adhesive onto a substrate, such as striped patterns and box-shaped patterns defined by zones of full volume adhesive and zones of reduced volume adhesive. The dispensing applicator includes a liquid dividing module positioned directly between a supply manifold and a dispensing module. The liquid dividing module divides flow of adhesive from the manifold into first and second partial flows of adhesive, one of which continuously flows to the dispensing module and another of which is controlled to either be recirculated or delivered to the dispensing module. These different operating states of the liquid dividing module therefore enable highly responsive and rapid switching between a reduced or partial volume output and a full volume output immediately before discharge at the dispensing module.

### TECHNICAL FIELD

The present invention relates generally to applicators for dispensing a pattern of adhesive onto a substrate, and more particularly, relates to an applicator including a plurality of modules configured to vary adhesive flow rates along and transverse to a machine direction defined by substrate movement past the applicator.

### BACKGROUND

Thermoplastic materials, such as hot melt adhesive, are dispensed and used in a variety of situations including the manufacture of diapers, sanitary napkins, surgical drapes as well as many others. This technology has evolved from the application of linear beads or fibers of material and other spray patterns, to air-assisted applications, such as spiral and meltblown depositions of fibrous material.

Often, the adhesive applicators will include one or more dispensing modules for applying the intended deposition pattern. Many of these modules include valve components to operate in an on/off fashion. One example of a dispensing module is disclosed in U.S. Pat. No. 6,089,413, assigned to the assignee of the present invention. This module includes valve structure which changes the module between ON and OFF conditions relative to the dispensed material. In the OFF condition, the module enters a recirculating mode. In the recirculating mode, the module redirects the pressurized adhesive material from the liquid material inlet of the module to a recirculation outlet which, for example, leads back into a supply manifold and prevents the adhesive material from stagnating. In the ON condition, the module delivers the adhesive material to a dispensing outlet for deposition on the substrate. Many other modules or valves have also been used to provide selective metering and on/off control of material deposition. For example, the known dispensing modules may be configured for contact dispensing or non-contact dispensing, such as spray dispensing, onto the target substrate to form the intended adhesive deposition pattern.

Various dies or applicators have also been developed to provide the user with some flexibility in dispensing material from a series of dispensing modules. For short pattern lengths, only a few dispensing modules are mounted to an integral manifold block. Longer applicators may be assembled by adding additional modules to the manifold. Additional flexibility may be provided by using different die tips or nozzles on the modules to permit a variety of deposition patterns across the applicator as well. The most common types of air-assisted dies or nozzles include meltblowing dies, spiral nozzles, and spray nozzles. Pressurized air used to either draw down or attenuate the fiber diameter in a meltblowing application, or to produce a particular deposition pattern, is referred to as process air. When using hot melt adhesives, or other heated thermoplastic materials, the process air is typically also heated so that the process air does not substantially cool the thermoplastic adhesive material prior to deposition of the adhesive material on the substrate or carrier. Therefore, the manifold or manifolds used conventionally to direct both adhesive material and process air to the module include heating devices for bringing both the thermoplastic material and process air to an appropriate application temperature.

In addition, it is also known that some articles of manufacture benefit from the use of reduced amounts of adhesive applied along certain portions of a deposition pattern. In order to achieve this varying amount of adhesive, multiple pumps and multiple valves are provided to feed a single dispensing outlet in the dispensing module (or two dispensing outlets configured to apply adhesive on the same portion of the substrate). One example of this type of system is disclosed in U.S. Patent Publication No. 2013/0274700, which is assigned to the assignee of the present invention. Such a system enables predictable variations in flow along a machine direction to thereby use reduced amounts of adhesive when these types of patterns are beneficial.

Despite these various improvements, it would be desirable to further enhance the operational functionality and efficiency of applicators for dispensing adhesive in various adhesive deposition patterns. To this end, it would be desirable to enable near-instantaneous modification of adhesive output volume without requiring duplicative valve and pump structures that can add to manufacturing costs and maintenance requirements for an applicator.

### SUMMARY

In accordance with one embodiment, a variable output dispensing applicator is configured to enable rapid transitions between full and partial volume dispensing states so as to produce various types of adhesive deposition patterns with zones of full volume adhesive and zones of reduced adhesive. In this regard, the applicator includes a manifold with a liquid supply passage and a liquid discharge outlet communicating with the liquid supply passage. The manifold delivers a flow of adhesive through the liquid discharge outlet. A liquid dividing module is coupled to the manifold and includes a liquid inlet, a liquid outlet, a recirculation passage communicating with the manifold, and internal passages extending between the liquid inlet and the liquid outlet. The liquid inlet communicates with the liquid discharge outlet of the manifold, and then the liquid dividing module divides this flow of adhesive from the liquid discharge outlet into a first partial flow of adhesive that continuously moves to the liquid outlet and a second partial flow of adhesive. The liquid dividing module controls the second partial flow to selectively provide full volume flow to the liquid outlet in a first operating state and to selectively provide reduced volume flow to the liquid outlet in a second operating state. To this end, the liquid dividing module includes a valve member configured to selectively control the movement of the second partial flow of adhesive to the liquid outlet by moving between an open position enabling communication with the liquid outlet and a closed position enabling communication with the recirculation passage. A dispensing module is coupled to the liquid dividing module and receives flow of adhesive from the liquid outlet. The dispensing module includes a dispenser outlet and a dispenser valve member that enables and disables flow from the liquid dividing module to the dispenser outlet.

In one aspect, the liquid dividing module is positioned in line with and directly between the manifold and the dispensing module such that the manifold and dispensing module are located on opposite sides of the liquid dividing module. This arrangement of elements enables the selective reduction of full volume flow to reduced volume flow to be generated adjacent to and immediately before discharge of the adhesive at the dispensing module.

The dispensing module further includes a second recirculation passage that receives flow of adhesive from the liquid outlet when the dispenser valve member disables flow to the dispenser outlet. The second recirculation passage is in communication with the manifold via the recirculation passage of the liquid dividing module, thereby providing a unitary recirculation flow path back into the manifold when partial or full volume flow needs to be returned to the manifold rather than dispensed.

In another aspect, the recirculation passage in the liquid dividing module is sized to control a percentage drop in flow between the liquid inlet and the liquid outlet when the valve member closes. For example, the recirculation passage may be sized to produce about 50% reduction of flow of adhesive between the full volume flow in the first operating state and the partial volume flow in the second operating state. To this end, the dispensing applicator operates as a pressure-based system when the valve member is closed because the pressure drop caused by flow through the recirculation passage (as compared to through the liquid outlet into the dispensing module) determines what portion or percentage of the flow will be diverted for recirculation out of the entire flow of adhesive entering the liquid inlet. Therefore, by modifying the size of the recirculation passage, the percentage reduction of flow of adhesive between the operating states could be modified in other embodiments.

The internal passages of the liquid dividing module include a valve chamber, a first internal passage, and a second internal passage. The valve chamber communicates with the recirculation passage and houses the valve member therein. The first internal passage extends directly from the liquid inlet to the liquid outlet without an interruption. The first internal passage may include multiple passage portions angled from one another such that the first internal passage bends around the valve chamber. The second internal passage extends from the liquid inlet to the valve chamber, and then from the valve chamber to the liquid outlet. Therefore, the valve member closes flow through this second internal passage to direct the flow in the second internal passage to the recirculation passage instead of the liquid outlet.

The dispensing applicator may be configured to dispense the flow of adhesive in a contact dispensing operation or in a non-contact dispensing operation, depending on the needs of the end user. In the non-contact spray dispensing setup, the dispensing module also includes a process air passage configured to discharge process air to control flow of adhesive exiting the dispenser outlet. The liquid dividing module, in such circumstances, includes a process air transmission passage that has multiple passage portions angled from each other such that the air transmission passage bends around the valve chamber.

As alluded to above, the dispensing applicator in one aspect is configured to produce patterns including varying volumes of adhesive both along a machine direction (defined by substrate movement past the dispensing module) and transverse to the machine direction. To this end, the manifold includes a plurality of liquid discharge outlets communicating with the liquid supply passage, and the applicator further includes a plurality of liquid dividing modules and a plurality of dispensing modules, each arranged in side-by-side relation. Each of the liquid dividing modules communicates with one of the liquid discharge outlets, and each of the dispensing modules communicates with a corresponding one of the liquid dividing modules. Moreover, the manifold may be segmented into a plurality of manifold segments, with each of the manifold segments including one of the liquid discharge outlets. Therefore, in such an arrangement, the transverse length of the dispensing pattern may be modified by adding or removing associated sets of manifold segments, liquid dividing modules, and dispensing modules.

Each of the plurality of liquid dividing modules includes a liquid outlet and a valve member as described above, with the valve member in the form of an air-actuated spring return valve for controlling the flow to the liquid outlet. Similarly, each of the plurality of dispensing modules includes a dispenser outlet and a dispenser valve as described above, with the dispenser valve in the form of an air-actuated spring return valve for controlling the flow to the dispenser outlet. The dispensing applicator then further includes a plurality of air control valves coupled to corresponding ones of the plurality of liquid dividing modules and the plurality of dispensing modules, thereby to control operation of the valve members and the dispenser valves. A control unit is operatively coupled to the plurality of air control valves and selectively activates the air control valves to produce output flows of adhesive at the dispensing modules that will vary along at least two directions to form the aforementioned patterns of adhesive on the substrate. For example, the control unit operates to provide full volume zones of adhesive and partial volume zones of adhesive that collectively define at least one of: a box shaped pattern, an hourglass shaped pattern, a striped pattern, an X-shaped pattern, and other known or desirable deposition patterns. Consequently, the dispensing applicator improves the functionality and responsiveness when controlling flow patterns of dispensed adhesive onto a substrate, in both contact and non-contact dispensing settings.

In accordance with another embodiment, a method for dispensing patterns of adhesive onto a substrate uses a variable output dispensing applicator with a manifold, a liquid dividing module, and a dispensing module, similar to the versions described above. The method includes delivering a flow of adhesive from the manifold into a liquid inlet of the liquid dividing module and dividing the flow of adhesive at the liquid dividing module into first and second partial flows of adhesive. The first partial flow of adhesive continuously moves to a liquid outlet of the liquid dividing module for entry into the dispensing module. The second partial flow of adhesive is controlled to selectively continue flowing to the liquid outlet and into the dispensing module in a first operating state of the liquid dividing module, and is controlled to selectively recirculate back to the manifold in a second operating state of the liquid dividing module. The method further includes dispensing adhesive received from the liquid outlet at the dispensing module onto the substrate. Therefore, a pattern of adhesive having varying amounts of adhesive is generated on the substrate by switching between the first and second operating states of the liquid dividing module while dispensing with the dispensing module. More particularly, the first operating state provides a full volume flow defined by the first and second partial flows of adhesive, and the second operating state provides a reduced volume flow of adhesive defined by only the first partial flow of adhesive.

In embodiments where the dispensing applicator includes a plurality of liquid dividing modules and a plurality of dispensing modules, the switching between first and second operating states of some or all of the liquid dividing modules leads to variations in full or partial volume flow both along a machine direction and transverse to a machine direction. Accordingly, various patterns of adhesive deposition are formed on the substrate, such as box shaped, hourglass shaped, and striped patterns. The method of dispensing may include spraying the adhesive from the dispensing module(s) in a non-contact operation, or alternatively, contact dispensing the adhesive from the dispensing module(s). The various methods above are explained in further detail below and these methods improve the functionality and responsiveness of dispensing patterns of adhesive onto a substrate, such as in the nonwovens construction field.

These and other objects and advantages of the disclosed apparatus will become more readily apparent during the following detailed description taken in conjunction with the drawings herein.

### BRIEF DESCRIPTION OF THE DRAWINGS

FIG. 1 is a front perspective view of a variable output dispensing applicator in accordance with one embodiment of the invention, the applicator including a manifold feeding adhesive into a plurality of liquid dividing modules, which then feed into a corresponding plurality of liquid dispensing modules.

FIG. 2 is a partially exploded perspective view of the applicator of FIG. 1, including an end plate of the manifold, one of the liquid dividing modules, and one of the dispensing modules being spaced apart from the corresponding portion of the manifold.

FIG. 3 is a front perspective view of the liquid dividing module used with the applicator of FIG. 1.

FIG. 4 is a rear perspective view of the liquid dividing module of FIG. 3.

FIG. 5 is a partially-phantom front perspective view of the liquid dividing module of FIG. 3 to show internal passages through the liquid dividing module in further detail.

FIG. 6 is a partially-phantom rear perspective view of the liquid dividing module of FIG. 3 to show internal passages through the liquid dividing module in further detail.

FIG. 7 is a side cross-sectional view of the liquid dividing module of FIG. 3, taken along line 7-7 in FIG. 4 so as to show a valve member of the liquid dividing module in an open position to deliver full volume flow to the liquid dispensing module.

FIG. 8 is a side cross-sectional view of the liquid dividing module similar to FIG. 7, taken along line 7-7 in FIG. 4 so as to show the valve member of the liquid dividing module in a closed position to recirculate a portion of the flow through the liquid dividing module.

FIG. 9 is a side cross-sectional view of the dispensing module used with the applicator of FIG. 1, taken along line 9-9 in FIG. 2 so as to show a dispenser valve in a closed position, thereby causing recirculation of the flow.

FIG. 10 is a side cross-sectional view of the dispensing module similar to FIG. 9, taken along line 9-9 in FIG. 2 so as to show the dispenser valve in an open position, thereby causing dispensing of adhesive through a dispensing outlet.

FIG. 11A is a schematic top view of a first adhesive deposition pattern using zones of full adhesive output and zones of reduced adhesive output in accordance with a first embodiment of use of the applicator of FIG. 1, the first adhesive deposition pattern defining a box-shaped pattern.

FIG. 11B is a schematic top view of a second adhesive deposition pattern using zones of full adhesive output and zones of reduced adhesive output in accordance with a second embodiment of use of the applicator of FIG. 1, the second adhesive deposition pattern defining a box-shaped pattern with diagonal lines of full adhesive output extending across the box-shaped pattern.

FIG. 11C is a schematic top view of a third adhesive deposition pattern using zones of full adhesive output, zones of reduced adhesive output, and zones of no adhesive output in accordance with a third embodiment of use of the applicator of FIG. 1, the third adhesive deposition pattern defining an hourglass-shaped pattern.

FIG. 11D is a schematic top view of a fourth adhesive deposition pattern using zones of full adhesive output and zones of reduced adhesive output in accordance with a fourth embodiment of use of the applicator of FIG. 1, the fourth adhesive deposition pattern defining a X-shaped and box-shaped pattern of full adhesive output in combination.

### DETAILED DESCRIPTION

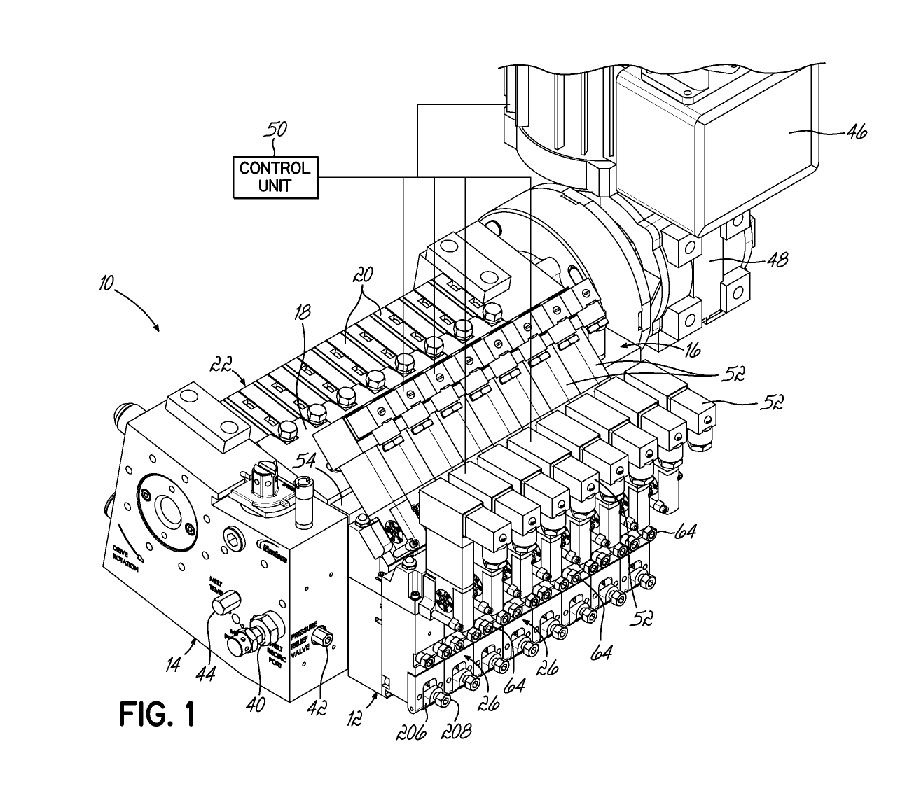

FIGS. 1 through 10 illustrate one embodiment of a variable output dispensing applicator 10 constructed in accordance with the concepts of this disclosure. To this end, the applicator 10 is configured to dispense patterns of adhesive onto a substrate moving with respect to the applicator 10, the patterns being defined at least by zones of full volume flow/output and zones of partial volume flow/output. Rather than providing duplicative overlapping dispensing structures to control two partial adhesive flows that may be dispensed onto each area of the substrate, the applicator 10 advantageously includes liquid dividing modules 12 (also referred to as “liquid dividing, supplying and recirculating modules”) that divide a full volume flow and selectively control whether a partial portion of the full volume flow reaches the corresponding associated dispensing modules. As a result, the adhesive flow variation is controlled in line with and immediately before delivery of the adhesive into the dispensing modules, which allows for increased responsiveness when dispensing patterns or states need to be changed during operation. Therefore, one or more desired patterns of adhesive, several examples of which are described in further detail below, can be reliably applied to the substrate with less adhesive material waste when using the applicator 10 of the current embodiment.

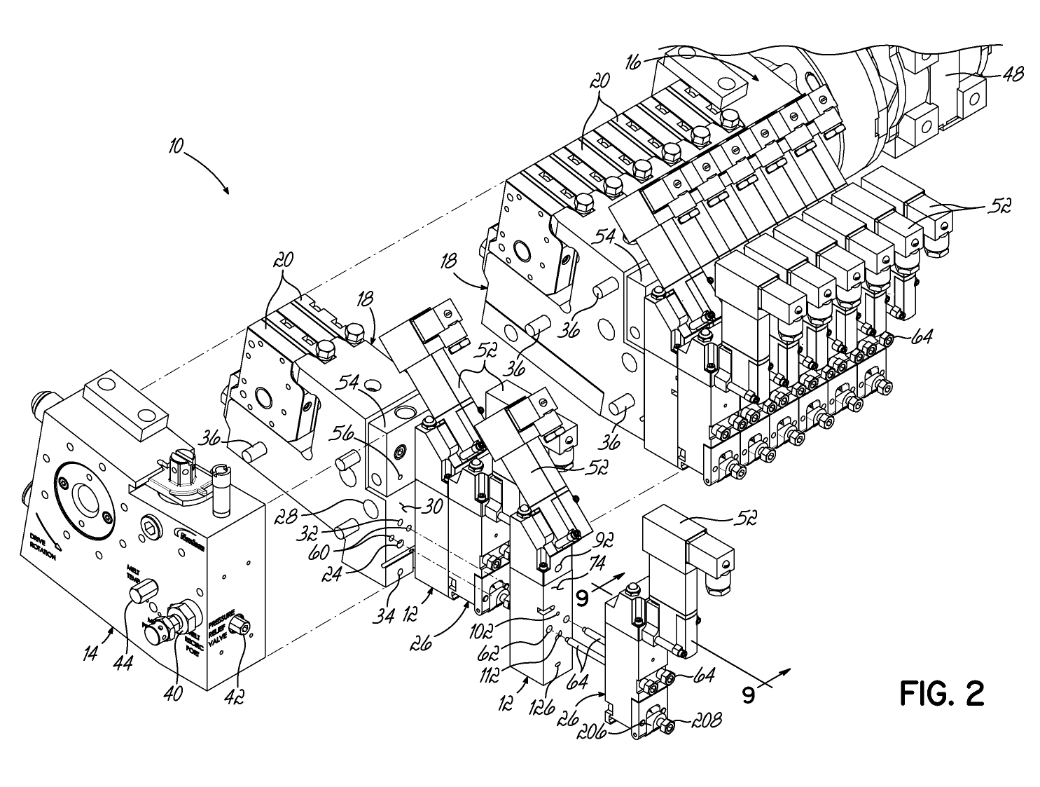

In addition to the liquid dividing modules 12, the applicator 10 includes many similar components as the modular dispensing applicator described in U.S. Pat. No. 6,422,428, assigned to the assignee of the present invention, and the disclosure of which is hereby fully incorporated by reference herein. To this end, the applicator 10 includes a pair of end plates 14, 16 sandwiching a plurality of individual side-by-side manifold segments 18 therebetween, with each of the manifold segments 18 being associated with a corresponding gear pump 20. The manifold segments 18 and end plates 14, 16 collectively define a manifold 22 of the applicator 10. These elements of the applicator 10 are shown in a fully assembled state in FIG. 1 and in a partially-exploded state in FIG. 2 for clarity. In general, a pressurized liquid adhesive such as hot melt adhesive is introduced into manifold segments 18 and is then metered by the gear pumps 20 individually associated with each manifold segment 18. This flow of adhesive is supplied to the liquid dividing modules 12 via a plurality of liquid discharge outlets 24, one of which is formed in each of the manifold segments 18, and the liquid dividing modules 12 then deliver some or all of this adhesive flow into a corresponding plurality of dispensing modules 26 located on an opposite side of the liquid dividing modules 12 as the manifold 22. The liquid discharge outlets 24 are effectively fed the flow of adhesive through a liquid supply passage 28 defined by the manifold segments 18, this flow being metered for each specific liquid discharge outlet 24 by the corresponding gear pump 20.

As shown most clearly in FIG. 2, each of the manifold segments 18 includes at least one of the liquid discharge outlets 24, with each of the liquid discharge outlets 24 connected to and associated with a liquid inlet of one of the liquid dividing modules 12. In the illustrated embodiment, each manifold segment 18 includes two liquid discharge outlets 24 feeding two of the liquid dividing modules 12, which are coupled to the corresponding manifold segment 18. However, it will be appreciated that each manifold segment 18 may include only one of the liquid discharge outlets 24 or more than two liquid discharge outlets 24 without departing from the scope of invention (e.g., so long as a corresponding number of liquid dividing modules 12 are connected to those manifold segments 18). Likewise, each manifold segment 18 as shown is engaged with two gear pumps 20 for metering flow to the corresponding liquid discharge outlets 24, although one gear pump 20 or more than two gear pumps 20 may be used with the manifold segments 18 in other similar embodiments.

The liquid discharge outlets 24 are defined in a series along a distal end surface 30 that is collectively defined by the manifold segments 18. This distal end surface 30 also includes a plurality of liquid recirculation inlets 32, each of which is typically positioned above a corresponding one of the liquid discharge outlets 24. As will be described further below, a partial portion or the full volume flow of adhesive delivered into the liquid dividing modules 12 and then the dispensing modules 26 may be recirculated back into the manifold 22 depending on the operating state of the liquid dividing modules 12 and the dispensing modules 26. Consequently, the flow of adhesive does not stagnate within the applicator 10 during operation, even if the dispensing operation of adhesive onto substrate(s) is temporarily halted.

The applicator 10 in some operations is configured to be used as a non-contact dispenser such as a spray dispenser, so the distal end surface 30 of the manifold segments 18 also includes a series of process air outlets 34 configured to be in fluid communication with the plurality of liquid dividing modules 12 (so as to then be passed on to the dispensing modules 26). The process air outlets 34 are located so as to be spaced below the liquid recirculation inlets 32 and the liquid discharge outlets 24, although it will be understood that the precise positioning of these outlets 24, 34 may be modified depending on the particular inlet configuration at the liquid dividing modules 12 in other embodiments. As readily understood in the hot melt dispensing field, the manifold 22 is typically heated using heater cartridges or similar elements (not shown) extending through the manifold segments 18, and the internal passageways for liquid adhesive and for process air are designed to enable heating of the air and adhesive to keep these elements at desirable temperature levels upon discharge from the dispensing modules 26. One particular layout of these internal manifold passages is described in the U.S. Pat. No. 6,422,428 referenced above, although no further detail is shown in the drawings or described herein (e.g., some of the manifold passages are only shown schematically in the drawings of this application).

As shown in FIGS. 1 and 2, the manifold segments 18 are maintained in alignment with one another when brought together between the two end plates 14, 16. For example, each manifold segment 18 further includes mating structures such as alignment rods 36 on one lateral side with corresponding alignment apertures (not shown) on the opposite lateral side. It will be understood that different mating structures, including alignment rods that extend through each of the manifold segments 18 may be used to accurately position the series of manifold segments 18 when assembling the manifold 22. The end plates 14, 16 also include corresponding mating structures configured to engage with those on the outermost manifold segments 18 as well, although these features are not visible in FIGS. 1 and 2. It will be understood that the manifold 22 and its accessories like the gear pumps 20 may therefore be secured together in assembly by fasteners, clamps, and other known fixating devices. When completely assembled, the manifold 22 takes up a minimum or optimized amount of volume or space that is required for supplying controlled metered amounts of liquid adhesive at a desired temperature into the liquid dividing modules 12 and the dispensing modules 26. This arrangement also enables the applicator 10 to be efficiently heated at the manifold 22, such as by heating cartridges (not shown) or other similar heating elements.

Returning to the end plates 14, 16, at least one of the end plates 14 (the one closest to the front in FIGS. 1 and 2) includes an inlet port for adhesive (not shown), an outlet port 40 for recirculating adhesive, and a pressure relief port 42 configured to discharge adhesive if the adhesive in the applicator 10 becomes over-pressurized. This end plate 14 may also include a temperature sensor 44 configured to measure and monitor the temperature of the liquid adhesive in the manifold 22, thereby to provide control to the heating elements described briefly above. The incoming adhesive material may also be transferred through a filter block (not shown) which may be secured to the end plate 14 in some embodiments. On the opposing end plate 16 in the embodiment shown in these Figures, a DC servo motor 46 and a right angle gear box 48 are provided to simultaneously drive each gear pump 20 coupled with the manifold segments 18. To this end, the servo motor 46 in this embodiment is connected to a control unit 50 of the applicator 10, shown schematically, the control unit 50 causing the servo motor 46 to drive a drive shaft extending from the gear box 48 through each of the adjacent gear pumps 20. As shown in FIGS. 1 and 2, it will be understood that both end plates 14, 16 are formed similarly so that the servo motor 46 and gear box 48 can be switched in position to connect to the other end plate 14 other embodiments consistent with the scope of the invention (likewise, the end plate 16 includes inlet and outlet ports which are plugged in the illustrated embodiment but would be used when the servo motor 46 and gear box 48 are repositioned in this manner).

As shown schematically in FIG. 1, the control unit 50 of the applicator 10 is also operatively coupled to a plurality of air control valves in the form of air solenoids 52 which serve the role of air control valves in this embodiment. Each of the plurality of air solenoids 52 is a conventional spool operated solenoid valve that is coupled to the upper portion of one of the liquid dividing modules 12 or one of the dispensing modules 26. The air solenoids 52 control air flows to the pneumatically-driven valve devices located inside the liquid dividing modules 12 and the dispensing modules 26 as set forth in greater detail below. Therefore, the control unit 50 of this embodiment is capable of operating the air solenoids 52 in a manner to cause the applicator 10 to dispense a specified pattern of adhesive on the substrate. Although one air solenoid 52 is provided for each of the modules in the illustrated embodiment, it will be understood that air solenoids 52 may be shared by multiple modules and also different types of alternative known air control valves may be used in other embodiments.

Moreover, as shown in FIG. 2, each of the manifold segments 18 further includes an air block 54 or air portion which receives the pressurized air that is to be used by the valve devices within the liquid dividing modules 12 and dispensing modules 26 and that is to be controlled by the air solenoids 52. The air blocks 54 communicate with one or more air inlets (not shown) connected to a pressurized air source, and each air block 54 includes at least one pressurized air outlet 56 generally located directly above the liquid discharge outlets 24 and liquid recirculation inlets 32 formed in the distal end surface 30 of the manifold 22. In the embodiment shown in the Figures, each of the pressurized air outlets 56 communicates with a control air inlet located in one of the corresponding liquid dividing modules 12. The flow and control of this air and the associated valve device functionality is described in further detail below with respect to the operation of the liquid dividing modules 12 and the dispensing modules 26.

The applicator 10 is shown in partially exploded view in FIG. 2 so as to reveal the method for assembling the liquid dividing modules 12 and the dispensing modules 26 to the corresponding manifold segments 18. To this end, the distal end surface 30 of the manifold 22 includes a pair of threaded apertures 60 located proximate to the liquid recirculation inlet 32 and the liquid discharge outlet 24. As will be readily understood, these threaded apertures 60 may be repositioned in other embodiments, but are provided at this location in the illustrated embodiment because this area corresponds to a central area of the liquid dividing modules 12 and the dispensing modules 26 (e.g., a good area to provide balanced support for these elements). The liquid dividing modules 12 and the dispensing modules 26 each include a pair of corresponding fastener through holes 62 that extend between proximal and distal sides (“proximal” and “distal” being implied relative to the manifold 22) of these elements. The fastener through holes 62 are positioned to be aligned with the threaded apertures 60 in one of the manifold segments 18, as shown in FIG. 2.

Consequently, an elongated and threaded assembly fastener 64 can be inserted through one of the fastener through holes 62 in the dispensing module 26 and through one of the fastener through holes 62 in the liquid dividing module 12 to engage with one of the threaded apertures 60 in the manifold segment 18. By tightening this assembly fastener 64, the liquid dividing module 12 is secured in abutting relation with the manifold segment 18 on one side and the dispensing module 26 on the other side. It will be understood that other clamps or securing members may be used to assemble the applicator 10 in other embodiments. However, regardless of the assembly mechanisms chosen, the applicator 10 may be configured in many different manners, such as with differing numbers of manifold segments 18, liquid dividing modules 12, and dispensing modules 26, depending on the particular application needs of the user. As a result, the various adhesive deposition patterns achievable with the applicator 10 may be modified in many different ways as will be understood in view of the detailed description of the modules and their functionality below.

Before turning to the detailed description of one of the illustrated embodiments of liquid dividing modules 12, it is noted that various embodiments of the applicator 10 may include different types of dispensing modules 26 (such as contact and non-contact dispensing modules) and different layouts or structures at the manifold 22 without departing from the scope of the described invention. Other modifications will be readily apparent and within the scope of this disclosure, such as, for example, the potential replacement of one or more gear pumps with a substitution block (not shown) which diverts adhesive material back into the corresponding manifold segment, as well as those alternatives described above. The provision of the liquid dividing modules 12 within the applicator 10 helps enable the advantageous functionality and dispensing variety of patterns described below.

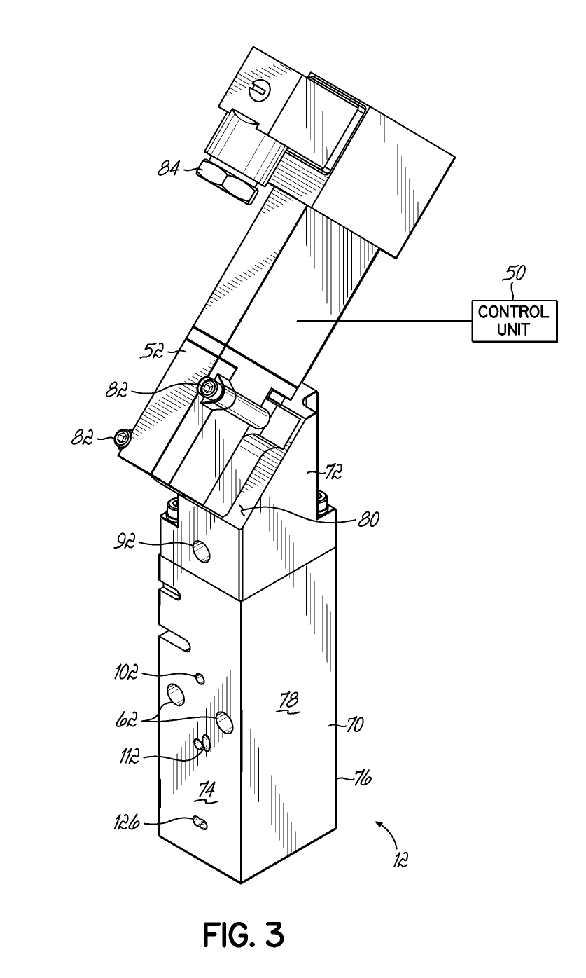

With reference to FIGS. 3 through 8, an embodiment of the liquid dividing module 12 used with the applicator 10 is shown in detail. The liquid dividing module 12 is advantageously configured to selectively reduce a full volume flow of adhesive received from the corresponding manifold segment 18 to a reduced or partial volume flow of adhesive adjacent to and immediately before that adhesive flow is delivered into and dispensed by the corresponding dispensing module 26. Accordingly, the dispensing module 26 can switch between dispensing a full volume flow and a partial volume flow rapidly on demand by virtue of operating the liquid dividing module 12 feeding the adhesive into the dispensing module 26. To this end, the quick responsiveness to control signals from the control unit 50 when modifying the amount of adhesive dispensed at the dispensing module 26 provides effective and predictable (e.g., controllable) patterns of deposition onto a substrate, which is advantageous in certain fields such as nonwoven garment construction.

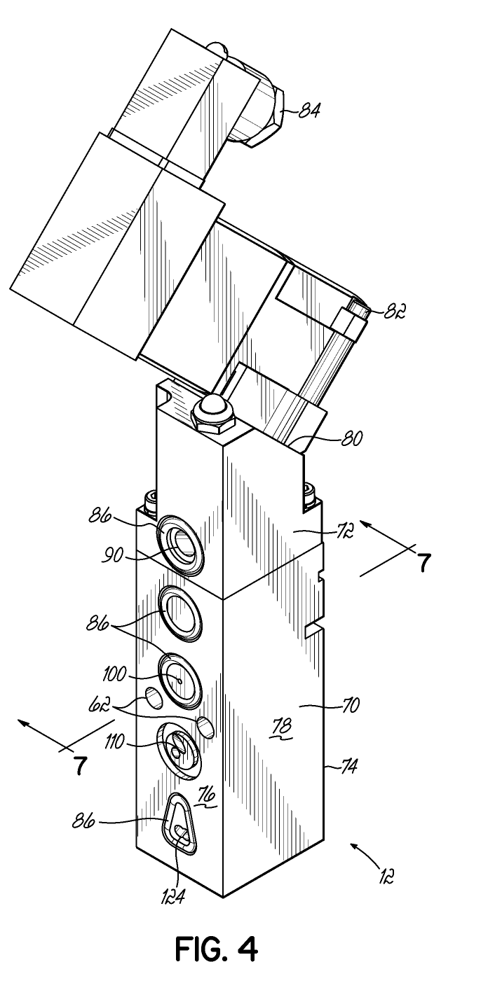

The external appearance and features of the liquid dividing module 12 of this embodiment are shown in FIGS. 3 and 4. The liquid dividing module 12 includes a liquid control section 70 and a control air section 72 mounted on top of the liquid control section 70. The liquid control section 70 is generally rectangular box-shaped in appearance, with an outer periphery defined by a distal wall 74 facing towards the dispensing module 26, a proximal wall 76 facing towards the manifold 22, and sidewalls 78 extending between the distal wall 74 and proximal wall 76. The control air section 72 provides an angled top mounting surface 80 for attaching the corresponding air solenoid 52 to, such as with threaded fasteners 82. As previously shown in the view of the entire applicator 10 in FIG. 1, this enables the air solenoid 52 on the liquid dividing module 12 to be in an inclined position that does not interfere with the dispensing module 26 or its associated air solenoid 52. The air solenoid 52 of this and other views in this application is a conventional commercially-available device including internal valve structure and a port 84 for connecting to an electrical supply and/or the control unit 50, but no further explanation of this element or its functionality will be necessary here to understand the scope of the recited invention.

With continued reference to FIGS. 3 and 4, the liquid dividing module 12 includes a series of inlets and outlets for the flow of process air, adhesive, and control air. Each of these elements is passed through the liquid dividing module 12 into the dispensing module 26 as set forth in further detail below, this arrangement resulting from the positioning of the liquid dividing module 12 directly between the manifold segment 18 and the dispensing module 26, of which the latter two elements were conventionally directly coupled to one another in known applicators. It will also be understood that each of the following inlets and outlets can be repositioned from the particular layout described below to make the liquid dividing module 12 compatible with other port arrangements provided in manifolds 22 and dispensing modules 26 in different embodiments of the applicator 10. Furthermore, although sealing grooves with seal gaskets 86 are shown only along the inlets/outlets provided on the proximal wall 76, it will be appreciated that these elements could instead be provided on the distal wall 74 and/or on the distal end surface 30 of the manifold 22 in similar embodiments.

Beginning with the control air section 72, the liquid dividing module 12 includes a control air inlet 90 positioned just above the proximal wall 76 of the liquid control section 70. The liquid dividing module 12 also includes a control air outlet 92 on an opposite side of the liquid dividing module 12 (but still at the control air section 72), for example, above the distal wall 74 of liquid control section 70. The control air inlet 90 is positioned into alignment and communication with the pressurized air outlet 56 located in the air block 54 of the corresponding manifold segment 18. This pressurized air flow from the air block 54 is continuously passed through a control air passage 94 extending between the control air inlet 90 and control air outlet 92 such that this pressurized air flow is also made available to the dispensing module 26 for use by its associated air solenoid 52. As described below, this control air passage 94 also communicates with the control structure of the air solenoid 52 mounted on the liquid dividing module 12 such that the air solenoid 52 determines whether this pressurized control air reaches a piston within the liquid dividing module 12. Therefore, the liquid dividing module 12 both utilizes the pressurized air and passes this air along for later use at the dispensing module 26.

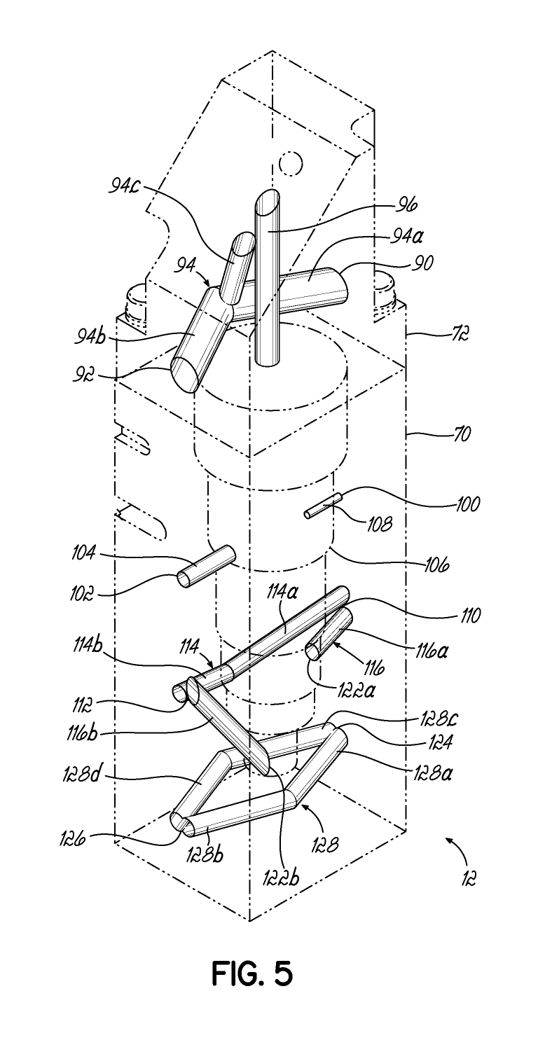

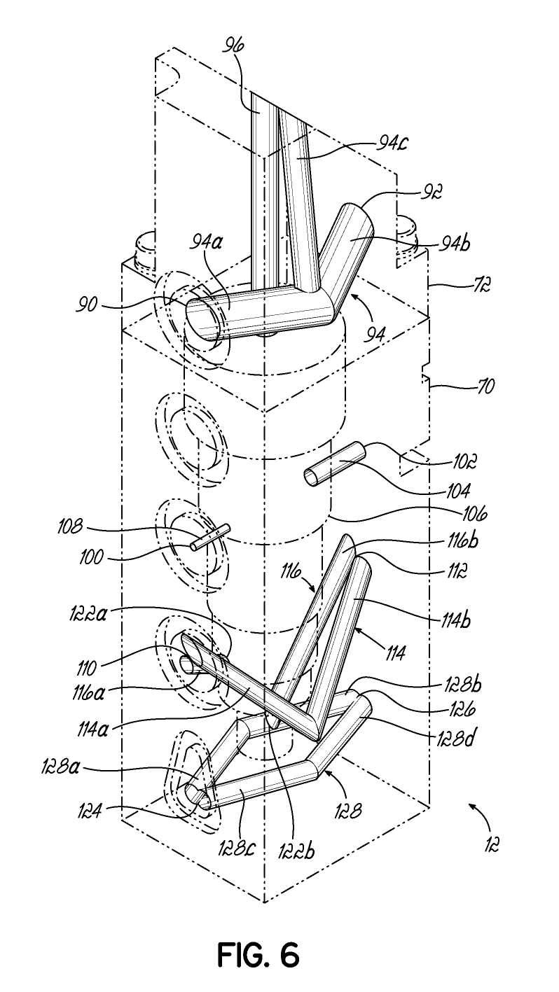

As noted above, the control air inlet 90 is surrounded by a seal groove and a seal gasket 86 which is configured to prevent leaks of the pressurized air from the interface between the distal end surface 30 of the manifold 22 and the proximal wall 76 of the liquid dividing module 12. Turning momentarily to FIGS. 5 and 6, which show most of the solid structure of the liquid dividing module 12 in phantom so as to reveal paths of internal passages in this liquid dividing module 12, the control air passage 94 includes two passage segments 94a, 94b which are angled from one another. This relative angling of the passage segments 94a, 94b (each of which is a straight bore) enables the control air passage 94 to bend around internal central structure within the liquid dividing module 12, and more specifically, around a central control air passage 96 (shown in phantom in FIGS. 5 and 6) delivering flow from the air solenoid 52 when activated to the piston described below. The first passage segment 94a communicates with the control air inlet 90 and the second passage segment 94b communicates with the control air outlet 92. The control air passage 94 also includes a third passage segment 94c which branches off from one or both of the other passage segments 94a, 94b and extends into communication with the air solenoid 52 (e.g., via a port along a top surface of the control air section 72) so as to provide the pressurized air to the air solenoid 52, for selective delivery back through the central control air passage 96 as described below. The specific path taken by the bending control air passage 94 may be modified in other embodiments depending on where the central control air passage 96 is located in those other embodiments, for example.

Continuing downwardly from the top of the liquid control section 70 in FIGS. 3 and 4, the liquid dividing module 12 also includes a liquid recirculation outlet 100 located along the proximal wall 76 and a liquid recirculation inlet 102 located along the distal wall 74. As noted above, the recirculation outlet 100 is surrounded by a seal groove with a seal gasket 86 in the illustrated embodiment, but it will be appreciated that the recirculation inlet 102 or both of these may include such a seal groove in other embodiments. The recirculation outlet 100 is positioned into alignment and communication with the liquid recirculation inlets 32 on the corresponding manifold segment 18 of the manifold 22. Accordingly, and as described in further detail below, the liquid dividing module 12 is capable of returning a partial portion or a full portion of the adhesive material to the manifold 22 when the dispensing module 26 is closed or only discharging a partial volume flow of the adhesive. As such, the recirculation outlet 100 defines part of the flow path which avoids stagnation of the adhesive within the liquid dividing module 12. The recirculation outlet 100 (and its associated outlet recirculation passage 108) is also advantageously sized to control the amount of adhesive which is recirculated during operation of the liquid dividing module 12, again as described in further detail below.

The recirculation inlet 102 of the liquid dividing module 12 is positioned so as to be in communication with a recirculation path within the dispensing module 26. Thus, regardless of the amount of flow of adhesive delivered by the liquid dividing module 12 into the dispensing module 26, the recirculation inlet 102 enables the return of that adhesive flow when the dispensing module 26 is closed, this flow then being recirculated into the manifold 22. The recirculation inlet 102 communicates with an inlet recirculation passage 104 in the liquid dividing module 12 that extends to a central valve chamber 106 shown in phantom in FIGS. 5 and 6, for example. The central valve chamber 106 is the location where the valve member (not shown in FIGS. 3 through 6) of the liquid dividing module 12 operates so that the central valve chamber 106 routes incoming and outgoing flows of adhesive from the appropriate inlets to the desired outlet(s). On the opposite side of the central valve chamber 106 from the inlet recirculation passage 104, an outlet recirculation passage 108 extends to communicate outgoing recirculated adhesive flow from the central valve chamber 106 to the recirculation outlet 100.

Therefore, this portion of the liquid dividing module 12 defines a recirculation path for adhesive flow coming from the dispensing module 26, this recirculation path defined by the recirculation inlet 102, the inlet recirculation passage 104, the central valve chamber 106, the outlet recirculation passage 108, and the recirculation outlet 100 in sequence. Likewise, the liquid dividing module 12 also defines a recirculation path for adhesive flow in the liquid dividing module 12 as follows: from the central valve chamber 106 through the outlet recirculation passage 108 and the recirculation outlet 100 in sequence.

Below the recirculation outlet 100 and recirculation inlet 102, the liquid dividing module 12 includes the fastener through holes 62 which extend all the way from the distal wall 74 to the proximal wall 76 so as to receive the elongated threaded assembly fasteners 64 connecting the liquid dividing module 12 in position between the dispensing module 26 and the manifold 22. The fastener through holes 62 are not shown in FIGS. 5 and 6, but they are laterally offset from the center of the liquid dividing module 12 so that the assembly fasteners 64 do not impinge upon the central valve chamber 106 located within the liquid dividing module 12.

Continuing to move downwardly from the fastener through holes 62 relative to the external view shown in FIGS. 3 and 4, the liquid dividing module 12 further includes a liquid inlet 110 located along the proximal wall 76 and a liquid outlet 112 located along the distal wall 74. The liquid inlet 110 is configured to be aligned into fluid communication with one of the liquid discharge outlets 24 provided at the manifold 22, thereby enabling an incoming flow of adhesive to be received within the internal passages of the liquid dividing module 12. As described above, the liquid inlet 110 is surrounded by a seal groove with a seal gasket (not shown in FIG. 4) in the illustrated embodiment, but it will be appreciated that the liquid outlet 112 or both of these elements may include such a seal groove in other embodiments. The liquid outlet 112 is configured to be aligned into fluid communication with an inlet on the dispensing module 26 connected to the liquid dividing module 12. To this end, the incoming flow of adhesive from the manifold 22 enters the liquid dividing module 12 at the liquid inlet 110 and then a full volume flow or a partial volume flow is delivered from the liquid dividing module 12 to the dispensing module 26 via the liquid outlet 112. The liquid inlet 110 and the liquid outlet 112 both have the appearance of two adjacent and optionally partially overlapping inlets/outlets based upon the formation of the internal passages described in further detail below, but these are treated as a single inlet 110 and a single outlet 112 for purposes of the functional discussion herein.

The liquid dividing module 12 shown in this embodiment also includes a first internal passage 114 and a second internal passage 116 extending between the liquid inlet 110 and liquid outlet 112, as shown most clearly in FIGS. 5 and 6. The first internal passage 114 includes two passage portions 114a, 114b which are angled from one another. This relative angling of the passage portions 114a, 114b (each of which is a straight bore in the illustrated embodiment) enables the first internal passage 114 to bend around the central valve chamber 106 within the liquid dividing module 12. The specific path taken by the first internal passage 114 may be modified in other embodiments without departing from the scope of this disclosure, but it will be understood that the two passage portions 114a, 114b of the illustrated embodiment are easily manufactured by drilling a straight bore into the liquid dividing module 12 from the corresponding proximal and distal walls 76, 74 thereof. As will be readily understood, the incoming flow of adhesive from the liquid discharge outlet 24 of the manifold 22 is divided into a first partial flow of adhesive in the first internal passage 114 and a second partial flow of adhesive in the second internal passage 116. The first partial flow of adhesive continuously moves directly from the liquid inlet 110 to the liquid outlet 112 via the first internal passage 114 without flowing through the central valve chamber 106. Accordingly, even when the valve structure within the liquid dividing module 12 is closed, this first partial flow of adhesive is delivered into the dispensing module 26 for selective discharge onto the substrate.

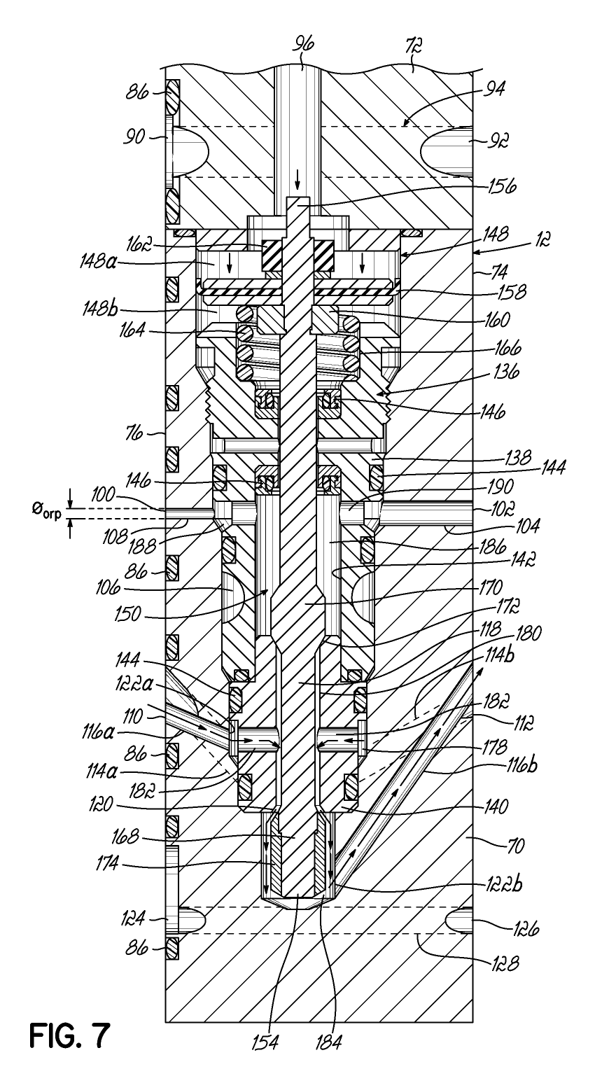

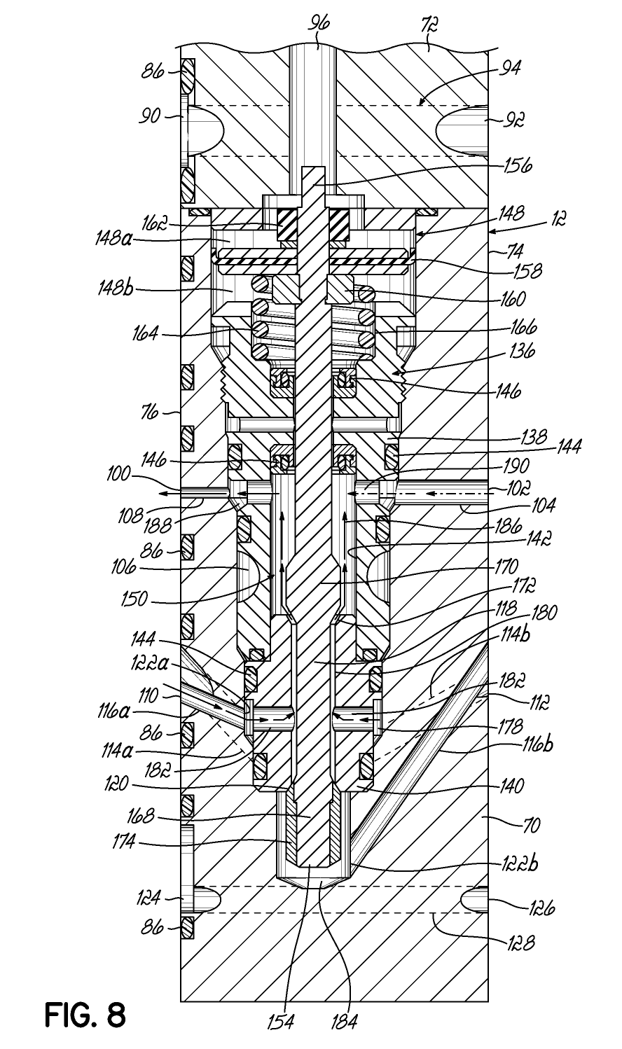

Returning to the internal structural features shown in FIGS. 5 and 6, the second internal passage 116 also includes two passage portions 116a, 116b which each intersect and communicate with the central valve chamber 106. More particularly, one of the passage portions 116a is a straight bore which extends between the liquid inlet 110 and the central valve chamber 106, and the other of the passage portions 116b is a straight bore which extends between the central valve chamber 106 and the liquid outlet 112. As set forth in further detail below, the liquid dividing module 12 includes a valve member 118 which selectively opens and closes flow by engaging with a first valve seat 120 (shown and described with further reference to FIGS. 7 and 8 below). This first valve seat 120 is located between an outlet 122a of the passage portion 116a which extends between the liquid inlet 110 and the central valve chamber 106, and an inlet 122b of the passage portion 116b which extends between the central valve chamber 106 and the liquid outlet 112. Thus, the opening and closing of the valve member 118 against the first valve seat 120 in the liquid dividing module 12 controls whether the second partial flow of adhesive moves into the second of the passage portions 116b for flow to the liquid outlet 112, so as to define a full volume flow when combined with the first partial flow of adhesive. When the valve member 118 is closed against the first valve seat 120, the second partial flow of adhesive is recirculated through the outlet recirculation passage 108 back to the manifold 22 instead of being delivered to the dispensing module 26. As a result, the flow through the second internal passage 116 determines whether the liquid dividing module 12 provides a full volume flow or a partial volume flow to the corresponding dispensing module 26. Once again, although the passage portions 116a, 116b of the second internal passage 116 are shown as separated straight bores for ease of manufacturing in the illustrated embodiment, the particular shape and layout of these passage portions 116a, 116b may be modified in other embodiments.

Finally, continuing to move downwardly from the liquid inlet 110 and liquid outlet 112 shown in FIGS. 3 and 4, the liquid dividing module 12 also includes a process air inlet 124 located along the proximal wall 76 generally underneath the liquid inlet 110 and a process air outlet 126 located along the distal wall 74 generally underneath the liquid outlet 112. The process air inlet 124 is configured to be aligned into fluid communication with one of the process air outlets 34 provided at the manifold 22, thereby enabling an incoming flow of process air to be received within a process air transmission passage 128 extending through the liquid dividing module 12. As described above, the process air inlet 124 is surrounded by a seal groove with a seal gasket 86 in the illustrated embodiment, but it will be appreciated that the process air outlet 126 or both of these elements may include such a seal groove in other embodiments. The process air outlet 126 is configured to be aligned into fluid communication with an inlet on the dispensing module 26 connected to the liquid dividing module 12. The process air inlet 124 and the process air outlet 126 both have the appearance of two adjacent and optionally partially overlapping inlets/outlets based upon the formation of the internal passages (e.g., drilled straight bores as described above for other similar passage segments or portions), but these are treated as a single inlet 124 and a single outlet 126 for purposes of the functional discussion herein.

Turning to FIGS. 5 and 6, which show most of the solid structure of the liquid dividing module 12 in phantom so as to reveal paths of internal passages in this liquid dividing module 12, the process air transmission passage 128 includes four passage segments 128a, 128b, 128c, 128d which are straight bores angled from one another. More specifically, two of the passage segments 128a, 128b extend between the process air inlet 124 and the process air outlet 126 while bending around the central valve chamber 106 on one lateral side, while the other two of the passage segments 128c, 128d extend between the process air inlet 124 and the process air outlet 126 while bending around the central valve chamber 106 on an opposite lateral side. This relative angling of the passage segments 128a, 128b and 128c, 128d enables the process air transmission passage 128 to bend around the internal central structure such as a bottommost end of the central valve chamber 106. The specific path taken by the process air transmission passage 128 may be modified in other embodiments without departing from the scope of this disclosure. However, the straight bore passage segments 128a, 128b, 128c, 128d enable the full flow of process air received in the liquid dividing module 12 from the manifold 22 to be delivered into the dispensing module 26, such as for use when the dispensing module 26 is a non-contact spray nozzle which uses process air to control the adhesive discharge. It will further be understood that the process air transmission passage 128 may be omitted or plugged when the dispensing module 26 used is a contact dispenser or a non-contact dispenser that does not require the use of process air for adhesive discharge and control.

With reference to FIGS. 7 and 8, the internal structure and components of the liquid dividing module 12 are shown in further detail along the cross section 7-7 in FIG. 4. Each of the inlets, outlets, and internal passages described above with reference to FIGS. 3 through 6 are visible again in this cross section, although some of the passages which angle around the central valve chamber 106 are shown in phantom. FIG. 7 specifically illustrates a first operating state of the liquid dividing module 12, in which the second partial flow of adhesive is allowed to flow to the liquid outlet 112 for delivery into the dispensing module 26, while FIG. 8 specifically illustrates a second operating state of the liquid dividing module 12, in which the second partial flow of adhesive is forced to recirculate to the manifold 22 via the liquid recirculation outlet 100. Various flow arrows are shown in these illustrations to provide clarity regarding the flow occurring through the liquid dividing module 12, and particularly within the central valve chamber 106 of the liquid dividing module 12. Advantageously, as will be described further below, although some of the internal passage structures differ in the liquid dividing module 12 compared to the dispensing module 26, the valve functionality and structure within the central valve chamber 106 is similar in the liquid dividing module 12 and the dispensing module 26 (which is also described further below). The differences in internal passage structures enable the difference that the liquid dividing module 12 controls only whether a partial portion of the adhesive from the manifold 22 is delivered into the dispensing module 26, while the dispensing module 26 controls whether all adhesive flow it receives is discharged onto a substrate or recirculated to the manifold 22.

As described previously, the central valve chamber 106 in the liquid dividing module 12 communicates with the passage portions 116a, 116b of the second internal passage 116 as well as with an inlet recirculation passage 104 extending from the dispensing module 26 and an outlet recirculation passage 108 leading to the manifold 22. The control air passage 94, the first internal passage 114, and the process air transmission passage 128 all bend around the central structure within the liquid dividing module 12 so as to not intersect with the central valve chamber 106. In this regard, the control air, the process air, and the first partial flow of adhesive move continuously through the liquid dividing module 12 from the manifold 22 into the dispensing module 26. The following description focuses on the internal valve structure and functionality of elements within the central valve chamber 106 of the liquid dividing module 12.

The central valve chamber 106 receives a valve stem casing, shown in the form of a removable cartridge 136. The removable cartridge 136 includes an upper cartridge portion 138, a lower cartridge portion 140, and a central through-bore 142 extending axially through the upper and lower cartridge portions 138, 140. The upper cartridge portion 138 of this embodiment is configured to be threadably engaged with a corresponding threaded portion of the central valve chamber 106; however, it will be understood that the removable cartridge 136 may be secured in position by other known methods in other embodiments. The upper and lower cartridge portions 138, 140 generally reduce in diameter or cross section moving downwardly (in the orientation shown in FIGS. 7 and 8) to match a similar stepped reduction in bore diameter defined along the length of the central valve chamber 106. The matching size and shape of the upper and lower cartridge portions 138, 140 with the central valve chamber 106, in combination with a plurality of annular seal gaskets 144 on the outer periphery of the upper and lower cartridge portions 138, 140, reduces the likelihood of any air or adhesive leaks from or between portions of the central valve chamber 106.

The central through-bore 142 is adapted to receive the valve member 118, such that the valve member 118 is freely movable along its longitudinal or central axis between open and closed positions. The removable cartridge 136 includes an interior seal assembly 146 located at the upper cartridge portion 138, this interior seal assembly 146 including dynamic seal gaskets which engage with the valve member 118 to prevent leakage between a piston chamber 148 defined by the central valve chamber 106 above the interior seal assembly 146 and an adhesive chamber 150 defined by the removable cartridge 136 and the central valve chamber 106 below the interior seal assembly 146. At all other locations along the length of the removable cartridge 136 (except selectively at two valve seats described below), the central through-bore 142 is sized to be larger than the valve member 118 to enable air or adhesive flow around the valve member 118 as required for proper functionality of the liquid dividing module 12.

With continued reference to FIGS. 7 and 8, the valve member 118 includes a lower stem end 154 extending through and beyond a terminal end of the lower cartridge portion 140 and an upper stem end 156 extending through and beyond a terminal end of the upper cartridge portion 138 into the piston chamber 148. The piston chamber 148 is more specifically formed collectively by an inner surface of the liquid control section 70 defining the central valve chamber 106, a lower surface of the control air section 72, and the terminal end of the upper cartridge portion 138. A piston 158 is mounted to the valve member 118 proximate the upper stem end 156, such as be being secured between a lower locking nut 160 and an upper locking nut 162 as shown in the illustrated embodiment. The piston 158 therefore moves within the piston chamber 148 in the direction of the longitudinal axis of the removable cartridge 136 or of the valve member 118, when the valve member 118 moves upwardly and downwardly. To this end, movements of the piston 158 effectively drive the movement of the valve member 118 between the open and closed positions. It will be understood that the piston 158 is sized to be closely received within the piston chamber 148, thereby dividing the piston chamber 148 into an upper piston chamber portion 148a and a lower piston chamber portion 148b.

The upper piston chamber portion 148a is in fluid communication with the central control air passage 96 extending generally vertically through the control air section 72. As described briefly above, the air solenoid 52 associated with the liquid dividing module 12 functions to selectively enable pressurized control air to be delivered into the upper piston chamber portion 148a via the central control air passage 96. The pressurized control air pushes the piston 158 downwardly towards the removable cartridge 136 when delivered into the upper piston chamber portion 148a. It will be appreciated that the lower piston chamber portion 148b may be vented to atmosphere by one or more bores (not shown) to enable movement of the piston 158 without formation of air pressure or vacuum that would impede this piston movement.

To move the piston 158 back away from the removable cartridge 136 when the pressurized control air is not being applied to the upper piston chamber portion 148a, a coil compression spring 164 is provided in the lower piston chamber portion 148b. More particularly, the coil compression spring 164 is partially received within an upper recess 166 formed in the terminal end of the upper cartridge portion 138 so as to encircle the valve member 118 between this upper recess 166 and the bottom side of the piston 158. As will be readily understood, the coil compression spring 164 applies a biasing force to move the piston 158 upwardly away from the removable cartridge 136, and this biasing force holds the piston 158 and the valve member 118 in an uppermost (closed) position until the pressurized control air is delivered into the upper piston chamber portion 148a to overcome the spring bias and push the piston 158 to a lowermost position. Accordingly, the movement of the piston 158 and the valve member 118 between positions is fully controlled by the selective supply of pressurized control air caused by the air solenoid 52 associated with the liquid dividing module 12.

In the illustrated embodiment of the liquid dividing module 12, the valve member 118 defines largely the same diameter or size along most of the length thereof, with two exceptions. To this end, the valve member 118 defines an enlarged first valve element 168 positioned adjacent the lower stem end 154 and an enlarged second valve element 170 located between the lower stem end 154 and the upper stem end 156. These enlarged portions of the valve member 118 defining the first and second valve elements 168, 170 are positioned in close relation to opposite (upper and lower) terminal ends of the lower cartridge portion 140 when the internal structure is fully assembled as shown in FIGS. 7 and 8. As a result, the lower cartridge portion 140 includes the first valve seat 120 located adjacent the first valve element 168 and a second valve seat 172 located adjacent the second valve element 170. The first and second valve seats 120, 172 are shaped to sealingly engage the corresponding surfaces on the first and second valve elements 168, 170 when those valve elements 168, 170 are brought into contacting engagement with the corresponding first and second valve seats 120, 172. For example, the enlarged portions defined by the first and second valve elements 168, 170 include angled transitions between the smaller diameter of the remainder of the valve member 118 and the enlarged diameter at the first and second valve elements 168, 170 in the illustrated embodiment, and the first and second valve seats 120, 172 provide angled complementary surfaces to sealingly engage with these angled transitions. However, it will be understood that alternative types of corresponding mirror image surfaces can be provided in the valve elements 168, 170 and in the valve seats 120, 172 in other embodiments consistent with this disclosure.

In order to enable the assembly of the removable cartridge 136 and the valve member 118 as shown in this embodiment, the enlarged first valve element 168 may be defined by a separately formed sleeve 174 fixed to the lower stem end 154 of the valve member 118. To this end, in the final assembled position shown in FIGS. 7 and 8, the enlarged first and second valve elements 168, 170 sandwich opposite ends of the lower cartridge portion 140, and similarly, the enlarged second valve element 170 is located between the interior seal assembly 146 which closely engages the valve member 118 and the lower cartridge portion 140. These structures could not be assembled in this arrangement without making at least the first valve element 168 adaptable to pass through the central bore through the lower cartridge portion 140. Consequently, the sleeve 174 is fixedly coupled to the lower stem end 154 after insertion of the lower stem end 154 through the bore of the lower cartridge portion 140.

In sum, these elements are assembled into the central valve chamber 106 by (1) inserting the upper stem end 156 of the valve member 118 through the interior seal assembly 146 of the upper cartridge portion 138, (2) inserting the lower stem end 154 (without the sleeve 174) through the lower cartridge portion 140, (3) connecting the upper and lower cartridge portions 138, 140 together with one another, (4) coupling the sleeve 174 to the lower stem end 154 to form the first valve element 168 of the valve member 118, (5) assembling the piston 158 to the upper stem end 156 with the lower and upper locking nuts 160, 162, and (6) inserting the assembly into the central valve chamber 106 from the top end of the liquid control section 70 and securing the assembly in position using the threaded engagement of the upper cartridge portion 138 with the central valve chamber 106. It will be understood that other assembly methods could be used in alternative embodiments, and elements like the separately formed sleeve 174 may be replaced or removed in such embodiments when not necessary to assemble the valve and cartridge components.

The removable cartridge 136 and central valve chamber 106 collectively define several additional passages or chambers for the adhesive flowing to and from the manifold 22 and the dispensing module 26. The lower cartridge portion 140 and central valve chamber 106 are spaced apart from one another adjacent the outlet 122a of the passage portion 116a of the second internal passage 116, thereby defining an inflow annular chamber 178 configured to receive the second partial flow of adhesive flowing in that passage portion 116a. The lower cartridge portion 140 also includes a central cartridge bore 180 extending between the first and second valve seats 120, 172 (e.g., the portion of valve member 118 between the first and second valve elements 168, 170 extends through this central cartridge bore 180 as well), the central cartridge bore 180 being in fluid communication with the inflow annular chamber 178 via one or more inflow bores 182 drilled through the lower cartridge portion 140 as shown in the Figures. In this regard, the second partial flow of adhesive flows from the passage portion 116a through the inflow annular chamber 178 and inflow bores 182 into the central cartridge bore 180, which directs the flow upwardly or downwardly depending on the open/closed state of the valve elements 168, 170 as described further below.

The central valve chamber 106 further includes an outflow chamber 184 extending below the lower cartridge portion 140 when the liquid dividing module 12 is fully assembled. This outflow chamber 184 communicates with the central cartridge bore 180 whenever the first valve element 168 is spaced apart from the first valve seat 120, such as in the operating state shown in FIG. 7 (also referred to as the open position). The outflow chamber 184 is also in communication with the inlet 122b of the passage portion 116b of the second internal passage 116 which communicates with the liquid outlet 112. Therefore, when the valve member 118 is moved downwardly to the so-called open position, the second partial flow of adhesive flows through the internal passages and chambers of the liquid dividing module 12 as shown by flow arrows in FIG. 7 so as to allow the second partial flow of adhesive to travel from the liquid inlet 110 to the liquid outlet 112.

The upper cartridge portion 138 defines a central recirculation bore 186 located above the lower cartridge portion 140 and below the interior seal assembly 146. The portion of the valve member 118 including the enlarged second valve element 170 is positioned to extend through this central recirculation bore 186. Furthermore, the upper cartridge portion 138 and central valve chamber 106 are spaced apart from one another adjacent the inlet recirculation passage 104 and the outlet recirculation passage 108, thereby defining a recirculation annular chamber 188 configured to receive any flows of adhesive being recirculated from the dispensing module 26 and/or the liquid dividing module 12 to the manifold 22. The central recirculation bore 186 is in fluid communication with the recirculation annular chamber 188 via one or more outflow bores 190 drilled through the upper cartridge portion 138 as shown in the Figures. As such, recirculation flows of adhesive from the dispensing module 26 and from the liquid dividing module 12 can be collected in the recirculation annular chamber 188 for return to the manifold 22 via the outlet recirculation passage 108.

In operation, the central recirculation bore 186 communicates with the central cartridge bore 180 whenever the second valve element 170 is spaced apart from the second valve seat 172, such as in the operating state shown in FIG. 8 (also referred to as the closed position in view of the second partial flow of adhesive being blocked from flow to the liquid outlet 112). Therefore, when the valve member 118 is moved upwardly to the so-called closed position, the second partial flow of adhesive flows through the internal passages and chambers of the liquid dividing module 12 as shown in FIG. 8 so as to allow the second partial flow of adhesive to travel from the liquid inlet 110 into the central recirculation bore 186 and then through the outflow bores 190, recirculation annular chamber 188, and outlet recirculation passage 108 back to the manifold 22. This flow action shown by flow arrows in FIG. 8 recirculates the second partial flow of adhesive instead of delivering it to the dispensing module 26, thereby defining the reduced volume flow state for the dispensing module 26.

Having described the recirculation flow that can occur in the liquid dividing module 12 when in the closed position, a further benefit or functionality of the liquid dividing module 12 can now be clarified. More specifically, the outlet recirculation passage 108 is a drilled bore with a specifically controlled size, shown as the diameter Ø_{ORP} in FIG. 7, and this size is selected or controlled so as to control the relative amounts of adhesive flow in the first and second partial flows of adhesive formed by the liquid dividing module 12. When the liquid dividing module 12 is in the closed position, the first partial flow of adhesive is discharged to the dispensing module 26 while the second partial flow of adhesive flows to the outlet recirculation passage 108 as shown and described above in connection with FIG. 8. These two flow paths through the liquid dividing module 12 and through the dispensing applicator 10 in its entirety inherently define respective pressure drops or flow resistances to the first and second partial flows of adhesive.

In one exemplary embodiment, the diameter Ø_{ORP} is about 0.030 inch, which causes the pressure drop through the recirculation path to be about the same as the pressure drop through the dispensing path. Accordingly, this selected diameter for the outlet recirculation passage 108 causes the flow resistance to be equal for the first and second partial flows of adhesive, thereby resulting in effectively an equal split of the flow at the liquid inlet 110 (e.g., the first partial flow is about 50% of the total adhesive flow and the second partial flow is also about 50% of the total adhesive flow). When in this closed position, the applicator 10 and the liquid dividing module 12 therefore operate as a pressure based system, and this enables the control of the relative amounts in the first and second partial flows of adhesive by adjusting or controlling the size of the outlet recirculation passage 108 (e.g., because this size helps determine the overall pressure drop in the recirculation path). If a different split of the volume is desired, such as 70/30% flow in the reduced volume flow state, the diameter Ø_{ORP} of the outlet recirculation passage 108 can be modified in other non-illustrated embodiments to provide such a result without departing from the scope of this disclosure. Generally speaking, as the outlet recirculation passage 108 decreases in size, the percentage of flow contained in the second partial flow of adhesive also decreases in size, thereby reducing the percentage volume reduction in the reduced volume flow state compared to the full volume flow state. Nevertheless, the many dispensing applications will require a 50/50% volume split, as advantageously provided in the illustrated embodiment.

Therefore, the liquid dividing module 12 advantageously operates to divide the incoming full volume flow from the manifold 22 into first and second partial flows of adhesive, the first of which is continuously delivered into the dispensing module 26 and the second of which is controlled to either flow to the dispensing module 26 or be recirculated back to the manifold 22. When the air solenoid 52 causes pressurized control air to flow into the upper piston chamber portion 148a and move the piston 158 and valve member 118 downwardly to the open position shown in FIG. 7, the second valve element 170 sealingly closes against the second valve seat 172 while the first valve element 168 is moved a small distance apart from the first valve seat 120. Thus, incoming flow of the second partial flow of adhesive is routed to the liquid outlet 112 so as to be rejoined with the first partial flow of adhesive before delivery as a full volume flow into the dispensing module 26.

When the pressurized control air is no longer delivered into the upper piston chamber portion 148a, the piston 158 is forced by the coil compression spring 164 to move upwardly to the closed position shown in FIG. 8. In this closed position, the first valve element 168 sealingly closes against the first valve seat 120 while the second valve element 170 is moved a small distance apart from the second valve seat 172. Thus, incoming flow of the second partial flow of adhesive is routed to the central recirculation bore 186 and to the outlet recirculation passage 108 so as to be recirculated to the manifold 22, leaving only the first partial flow of adhesive to flow into the dispensing module 26 as a reduced volume flow state.

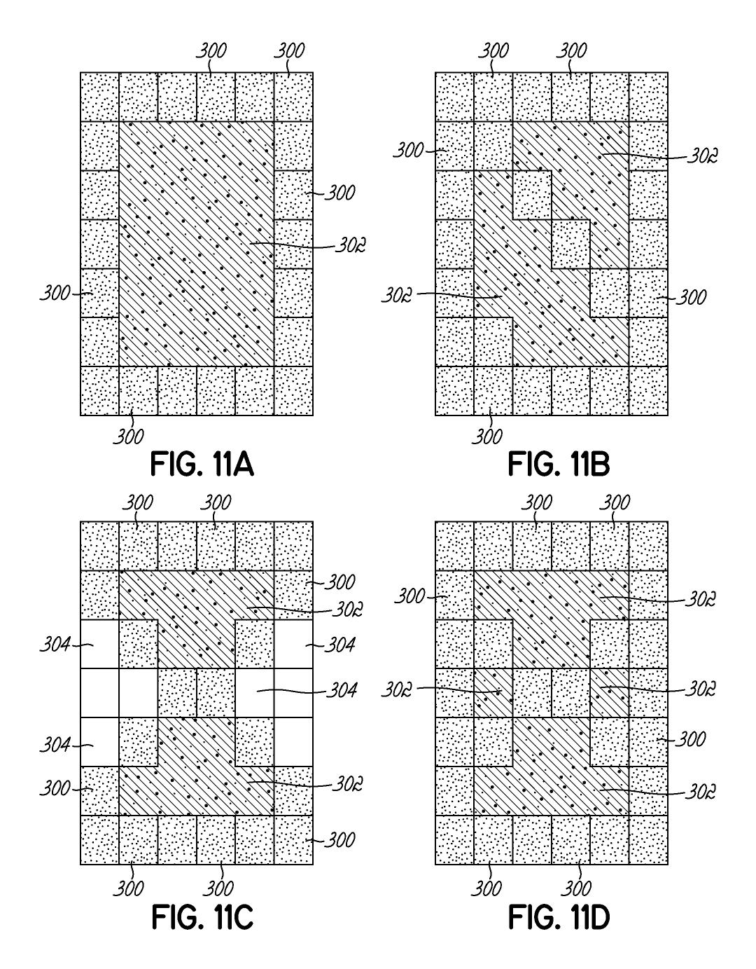

In an exemplary embodiment, the movement of the piston 158 and the valve member 118 between these positions can be defined by a short overall stroke length, such as a stroke length of about 0.020 inch. Accordingly, the movement of the valve member 118 to change between these full volume flow and reduced volume flow states is nearly instantaneous from when the control signal is provided to operate the air solenoid 52. And as the liquid dividing module 12 provides this functionality directly in line with and between the manifold 22 and the dispensing module 26, the selective and nearly instantaneous reduction of flow volume advantageously occurs adjacent to and immediately before discharge of the adhesive at the dispensing module 26. To this end, the liquid dividing module 12 enables the dispensing applicator 10 to be highly responsive and quick to change dispensing states between reduced volume flow and full volume flow, as may be required when dispensing controlled patterns of adhesive onto a substrate. Consequently, many different flow patterns can be predictably and reliably achieved using the applicator 10 of this embodiment, with several example flow patterns described below with reference to FIGS. 11A through 11D.

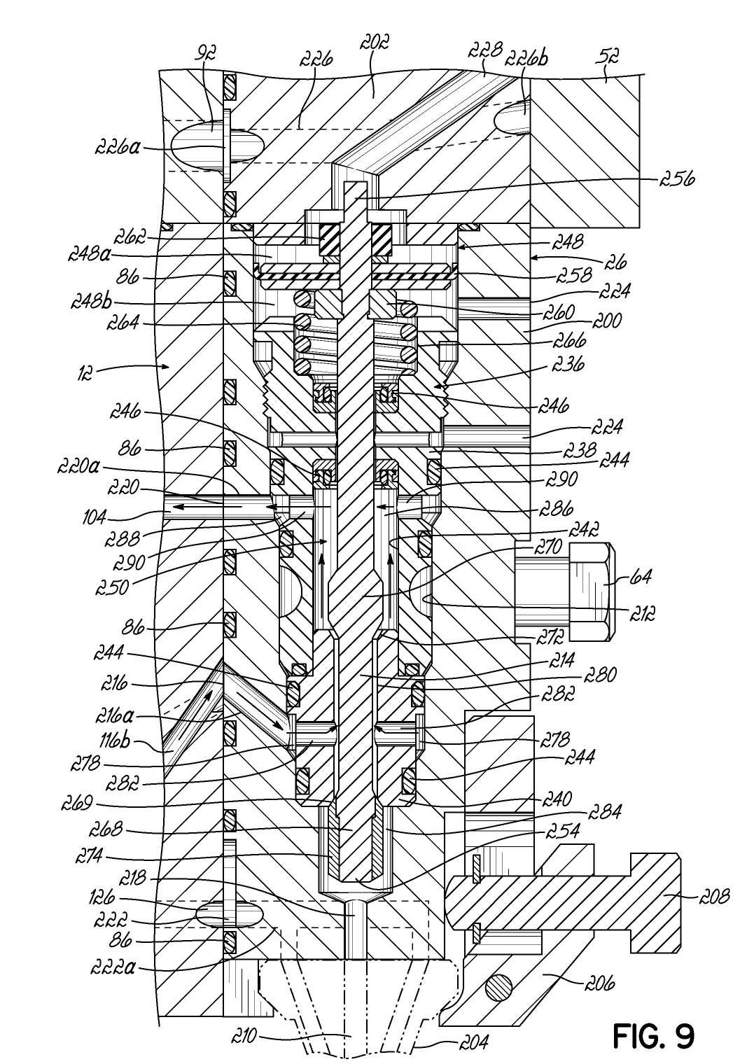

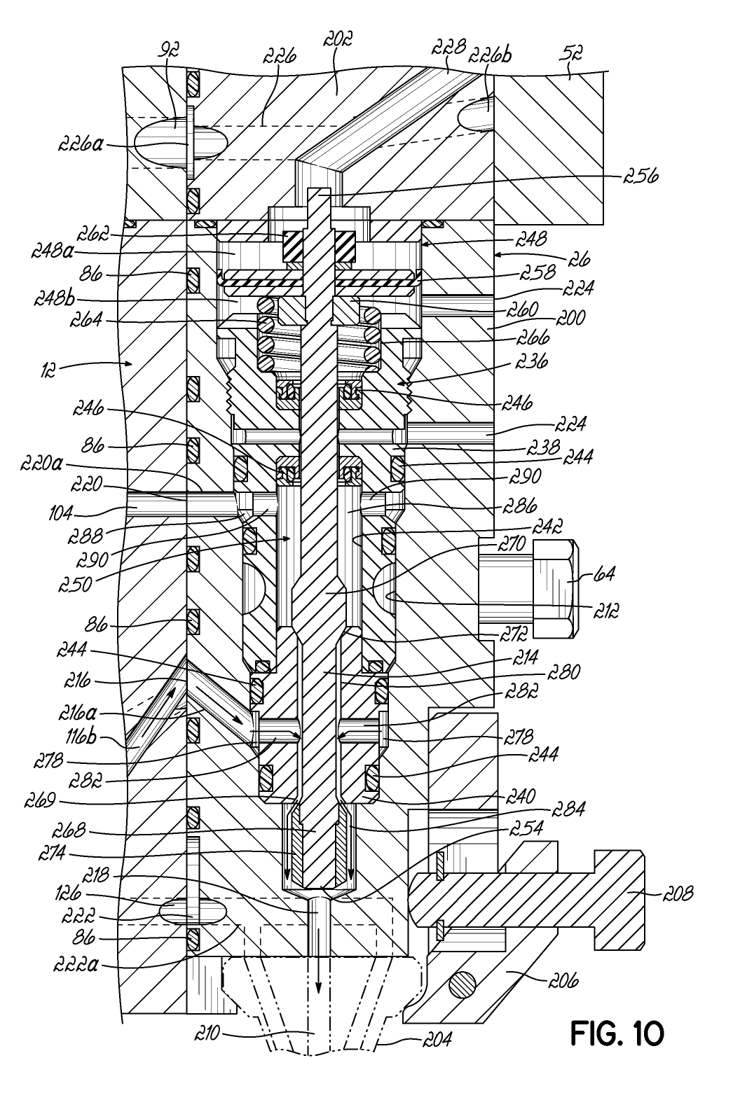

Now turning with reference to FIGS. 9 and 10, one embodiment of the dispensing module 26 used with this dispensing applicator 10 is shown in further detail to illustrate the internal passages and elements thereof. As briefly described above, the internal valve and cartridge components of the dispensing module 26 are similar to those described above for the liquid dividing module 12, and as such, a more limited explanation of these similar elements is provided below where the functionality is largely the same. Moreover, the same reference numbers in the 200 series are used below to describe the internal elements that were used for internal elements of the liquid dividing module 12 where they are substantially identical, such as the removable cartridge 236 of the dispensing module 26 being comparable in structure and function to the removable cartridge 136 described above for the liquid dividing module 12. However, it will be understood that the particular dispensing module 26 may be modified or replaced with other known dispensing modules 26 in alternative embodiments, without departing from the scope of this disclosure. For example, the dispensing module 26 could be in accordance with the module described in U.S. Pat. No. 6,089,413, which is owned by the assignee of the present application. In short, the dispensing module 26 must provide the capability to receive adhesive flow from the liquid dividing module 12 and then control whether that adhesive flow is dispensed to a substrate or recirculated, e.g., via the liquid dividing module 12 to the manifold 22.

Returning to FIGS. 9 and 10, the dispensing module 26 of the illustrated embodiment includes a module body 200, an air cap 202 operatively coupled to an upper portion of the module body 200, and a dispensing nozzle 204 (shown in phantom) releasably coupled to a lower portion of the module body 200 with a nozzle retaining clamp 206 having a clamp screw 208. As readily understood, the clamp screw 208 is threadably engaged with the nozzle retaining clamp 206 so that the clamp 206 can releasably retain the dispensing nozzle 204 in position at the bottom end of the module body 200. The dispensing nozzle 204 may be one of any number of known nozzles for discharging an adhesive flow in a non-contact or contact manner on a substrate, and this dispensing nozzle 204 is replaceable at the nozzle retaining clamp 206 so that different dispensing types and patterns may be used with the applicator 10. It will be understood that the dispensing nozzle 204 and its associated dispenser outlet 210 may in other embodiments be integrally incorporated as part of the dispensing module 26.

The module body 200 includes a main internal chamber 212 which houses a dispenser valve member 214 and various other internal elements described further below. Along a wall of the module body 200 that faces towards and contacts the distal wall 74 of the liquid dividing module 12 when the applicator 10 is assembled as shown in FIG. 1, the module body 200 includes a liquid inlet 216 configured to be aligned with and placed in fluid communication with the liquid outlet 112 of the liquid dividing module 12. The liquid inlet 216 communicates with an inlet passage 216a which extends inwardly in an angularly downward manner as shown in FIGS. 9 and 10 to communicate with the main internal chamber 212. Accordingly, the liquid inlet 216 and inlet passage 216a deliver the partial volume flow or full volume flow of adhesive received from the liquid dividing module 12 into the main internal chamber 212, where this flow is selectively controlled to be dispensed or recirculated. The module body 200 also includes a liquid dispensing outlet passage 218 which extends downwardly from the main internal chamber 212 towards a bottom of the module body 200, specifically where the dispensing nozzle 204 is engaged with the module body 200. Therefore, the liquid dispensing outlet passage 218 is adapted to direct adhesive material into the dispensing nozzle 204 for discharge onto the substrate when the dispenser valve member 214 opens flow for dispensing instead of recirculation.

Above the liquid inlet 216, the module body 200 further includes a liquid recirculation outlet 220 which is the termination point of a liquid recirculation outlet passage 220a. The liquid recirculation outlet passage 220a is adapted to direct adhesive material from the main internal chamber 212 toward the liquid dividing module 12 and its corresponding liquid recirculation inlet 102 during a liquid recirculation mode in which the dispenser valve member 214 opens flow for recirculation instead of dispensing. Below the liquid inlet 216, the module body 200 also includes a process air inlet 222 that communicates with the process air outlet 126 in the liquid dividing module 12 when the applicator 10 is fully assembled as shown. The process air inlet 222 communicates with process air passages 222a (shown in phantom in FIGS. 9 and 10) which are adapted to receive the supply of pattern/process air from the liquid dividing module 12 and then direct this process air into corresponding passages (shown in phantom) of the dispensing nozzle 204 for use in producing a liquid spray pattern in a non-contact dispensing mode for the dispensing module 26. It will be understood that the process air inlet 222 may be omitted or plugged when the dispensing nozzle 204 used is a contact nozzle which does not use pressurized process air for pattern control. Furthermore, the exterior surface of the module body 200 may include a series of seal grooves and seal gaskets 86 facing the liquid dividing module 12 and surrounding these various inlets and outlets, similar to the seal gaskets 86 provided on the liquid dividing module 12 and facing the interface with the manifold 22, and these seal gaskets 86 may alternatively be provided in the distal wall 74 of the liquid dividing module 12 without departing from the scope of this disclosure.

On an opposite side of the module body 200 from the abutment with the liquid dividing module 12, the dispensing module 26 includes one or more vents 224 configured to avoid build up of positive or negative air pressures within portions of the main internal chamber 212 that could negatively affect the operation of the dispenser valve member 214. For example, one of the vents 224 shown in FIGS. 9 and 10 communicates with the lower piston chamber portion 248b for similar reasons as described above (e.g., to accommodate the piston 258 movements driving the dispenser valve member 214). The nozzle retaining clamp 206 is also typically provided on this opposite side so as to enable easy access to the clamp 206 and the clamp screw 208 even when the applicator 10 is fully assembled.

The air cap 202 includes a control air passage 226 that extends from a control air inlet 226a, which is adapted to receive a supply of pressurized control air from the control air outlet 92 of the liquid dividing module 12, to a control air outlet 226b. The control air outlet 226b communicates with the air solenoid 52 which is coupled to the air cap 202, such as by using conventional threaded fasteners as well understood. Similarly to the control air section 72 of the liquid dividing module 12, the air cap 202 also includes a central control air passage 228 which returns the pressurized control air from the air solenoid 52 when the air solenoid 52 is actuated to provide pressurized air flow to move the dispenser valve member 214. The control air passage 226 may be formed with multiple angled portions to bend around the central control air passage 228, similar to that described above for the control air passage 94 in the liquid dividing module 12. The air solenoid 52 is operable to selectively direct the incoming pressurized control air into an upper piston chamber portion 248a to actuate internal components of the dispensing module 26, described below, to shift the dispensing module 26 between a liquid dispensing mode and a liquid recirculation mode.

With continued reference to FIGS. 9 and 10, the remaining internal components of the dispensing module 26 are largely identical to the control valving and internal components used in the liquid dividing module 12 and described in detail above. A brief summary of these elements is now provided for the sake of completeness. To this end, the dispensing module 26 includes a removable cartridge 236 defined by an upper cartridge portion 238 and a lower cartridge portion 240 collectively defining a central through-bore 242 configured to receive the dispenser valve member 214 therein. The removable cartridge 236 again includes annular seal gaskets 244 at an outer periphery to seal into engagement with the main internal chamber 212 of the module body 200, and also includes an interior seal assembly 246 engaging with the dispenser valve member 214 to separate an air portion from an adhesive portion in the dispensing module 26. In this regard, a piston chamber 248 having upper and lower piston chamber portions 248a, 248b is provided above the interior seal assembly 246 while an adhesive chamber 250 is provided below the interior seal assembly 246.

The dispenser valve member 214 extends from a lower stem end 254 to an upper stem end 256, with a piston 258 mounted near the upper stem end 256 using a lower locking nut 260 and an upper locking nut 262. The piston 258 is mounted for movement in the piston chamber 248 and is biased upwardly by a coil compression spring 264 towards a closed position defined by the recirculation mode. The coil compression spring 264 is at least partially located within an upper recess 266 formed in the upper cartridge portion 238 at a top end thereof. Thus, pressurized air controlled by the air solenoid 52 can be delivered via the central control air passage 228 to the upper piston chamber portion 248a to move the piston 258 and the dispenser valve member 214 against the spring bias to the open position defining the liquid dispensing mode. Moreover, the dispenser valve member 214 is an air-actuated spring return valve, just like the valve member 118 in the liquid dividing module 12.

The dispenser valve member 214 includes two enlarged valve elements, a first valve element 268 being provided adjacent the lower stem end 254 and a second valve element 270 being provided between the lower and upper stem ends 254, 256. The first valve element 268 is configured to selectively engage with a first valve seat 269 provided on the lower cartridge portion 240. When the first valve element 268 is engaged with the first valve seat 269, which is in the closed position or the recirculation mode shown in FIG. 9, the incoming adhesive material from the liquid dividing module 12 is blocked from flow to the dispensing nozzle 204, thereby shutting off adhesive flow from the dispensing module 26. When the first valve element 268 is pushed away from the first valve seat 269 by movement of the piston 258 with the pressurized control air from the air solenoid 52, adhesive flow to the dispensing nozzle 204 and to the dispenser outlet 210 occurs as shown by the flow arrows in FIG. 10, e.g., in the open position or the liquid dispensing mode. The second valve element 270 is configured to selectively engage with a second valve seat 272 formed on an opposite end of the lower cartridge portion 240 than the first valve seat 269. The second valve element 270 is spaced from the second valve seat 272 to enable incoming flow of adhesive to be recirculated when the first valve element 268 is engaged with the first valve seat 269. Likewise, the second valve element 270 engages with the second valve seat 272 to block recirculation flow when the first valve element 268 is spaced apart from the first valve seat 269. As described above, the first valve element 268 may be at least partially defined by a removable sleeve 274 engaged with the lower stem end 254, thereby enabling assembly of the internal valve and cartridge components as shown in the Figures.

An inflow annular chamber 278 is defined between the lower cartridge portion 240 and the module body 200, this inflow annular chamber 278 receiving the flow from the liquid inlet passage 216a. A plurality of inflow bores 282 extend radially through the lower cartridge portion 240 to provide adhesive communication from the inflow annular chamber 278 into a central cartridge bore 280 defined along the length of the lower cartridge portion 240 and between the first and second valve seats 269, 272. The adhesive flow into the central cartridge bore 280 selectively then moves into an outflow chamber 284 surrounding the lower stem end 254 when the first valve element 268 is spaced apart from the first valve seat 269, the outflow chamber 284 in communication with the liquid dispensing outlet passage 218 extending to the dispensing nozzle 204. Alternatively, the adhesive flow into the central cartridge bore 280 moves into a central recirculation bore 286 defined within the upper cartridge portion 238 above the second valve seat 272 when the second valve element 270 is spaced apart from the second valve seat 272. From the central recirculation bore 286, the flow of adhesive to be recirculated then moves through a plurality of outflow bores 290 drilled radially through the upper cartridge portion 238 so as to feed a recirculation annular chamber 288 defined between the upper cartridge portion 238 and the module body 200. This recirculation annular chamber 288 also communicates with the liquid recirculation outlet passage 220a, which as described above, leads the adhesive flow back into the liquid dividing module 12 for delivery to the manifold 22 as described above.

Thus, regardless of whether the dispensing module 26 receives a full volume flow or a partial volume flow of adhesive from the liquid dividing module 12, the dispensing module 26 is capable of rapidly switching between the liquid dispensing mode, which discharges the received adhesive flow onto a substrate, and the recirculation mode, which returns the received adhesive for flow back into the manifold 22. As noted above, different types of contact and non-contact dispensing modules and corresponding nozzles may be used in other embodiments of the applicator 10.

As briefly described above, the variable output dispensing applicator 10 of the illustrated embodiment advantageously enables near-instantaneous transitions between a full volume flow, a partial volume flow, and no volume flow at each set of liquid dividing module 12 and its corresponding dispensing module 26 across the width of the applicator 10. Therefore, when each of the dispensing modules 26 is configured to dispense adhesive onto a strip or lane of the substrate that is 25 millimeters wide, for example, the pattern can be modified in both contact and non-contact dispensing applications both along the machine direction or length of the substrate and in the transverse direction or across the width of the substrate (in 25 millimeter increments). This functionality results in any number of precise patterns being provided across a two-dimensional space defined by the substrate, and several examples of these patterns are shown in FIGS. 11A through 11D.

More specifically, the control unit 50 operates the air solenoids 52 and the associated valve structures within the liquid dividing modules 12 and the dispensing modules 26 to produce the varied volume zones of adhesive on the substrate, thereby generating patterns such as the box-shaped pattern in FIG. 11A, the striped pattern in FIG. 11B, the hourglass-shaped pattern in FIG. 11C, the X-shaped pattern in FIG. 11D, and other readily understood or desirable deposition patterns. Furthermore, the dispensing width of the pattern to be applied to the substrate may be quickly modified simply by placing the dispensing modules 26 of all lanes/strips not to be used into a recirculation mode for a given substrate. The applicator 10 does not need reconfigured each time the pattern or dispensing width needs to be modified.

With specific reference to FIG. 11A, which is a box-shaped pattern of adhesive, the pattern generated by the control unit 50 and the applicator 10 includes zones of full adhesive flow 300 forming a perimeter around an internal area defined by zones of reduced adhesive flow 302 on the substrate. The zones of full adhesive flow 300 are shown in box-like partial portions to help clarify the operation, but it will be appreciated that these zones will combine together into a unitary full volume perimeter in actual dispensed patterns on the substrate.

To form the pattern of FIG. 11A, six sets of liquid dividing modules 12 and dispensing modules 26 are controlled using the control unit 50. As described above, each of the liquid dividing modules 12 is dividing a flow of adhesive from the corresponding manifold segment 18 into first and second partial flows, one of which is always delivered into the dispensing module 26 and the other of which is controlled by the valve member 118. Each of the dispensing modules 26 controls with a dispenser valve member 214 whether the incoming adhesive from the liquid dividing module 12 is dispensed onto the substrate or recirculated back to the manifold segment 18 via the liquid dividing module 12. To this end, for a first set of zones shown at the uppermost part of the pattern in FIG. 11A, the control unit 50 actuates the air solenoids 52 for both the liquid dividing module 12 and the dispensing module 26 in every one of the six lanes across the width of the pattern or substrate. This causes the full volume flow of adhesive to be delivered by the liquid dividing modules 12 into the dispensing modules 26, and then the full volume flow is discharged from the dispenser outlets 210 of each of the dispensing modules 26, thereby forming a series of zones of full adhesive flow 300. Accordingly, the full volume flow or zones of adhesive are applied across the entire width of the pattern (150 millimeters in width in the example where each zone is 25 millimeters wide).

When the substrate reaches the second set of zones (moving downwardly from the top row of zones shown in FIG. 11A), the control unit 50 switches the operating states of the liquid dividing modules 12 in the second, third, fourth, and fifth lanes but maintains all other air solenoids 52 the same as before. As a result, the dispensing modules 26 in the first and sixth lanes (e.g., the outermost lateral lanes) continue to discharge the full volume flow of adhesive to generate additional zones of full adhesive flow 300 on the substrate. At the same time, the liquid dividing modules 12 in the second through fifth lanes recirculate the second partial flow of adhesive such that only the first partial flow of adhesive is received by the corresponding dispensing modules 26 (because the pistons 158 and valve members 118 of these liquid dividing modules 12 are returned by the spring bias to the closed position), and this reduced flow of adhesive is dispensed by these dispensing modules 26 to form the zones of reduced adhesive flow 302 on the substrate in these central lanes. This process may repeat for a number of zones along the length of the substrate (five shown in FIG. 11A), and then the control unit 50 may actuate all of the air solenoids 52 once again to provide zones of full adhesive flow 300 across the entire width of the substrate to finish the box-shaped pattern. If it would be desired to have no adhesive flow in the center of the box-shaped pattern rather than zones of reduced adhesive flow 302, the only change would be that the control unit 50 would switch the operating states of the dispensing modules 26 in those lanes instead of the liquid dividing modules 12 as described above.

One example of a pattern with zones of no adhesive flow 304 is the hourglass-shaped pattern shown in FIG. 11C. The zones of full adhesive flow 300 are applied across the entire width of the substrate at the beginning and end of the pattern once again, but between those ends, the zones of full adhesive flow 300 are selectively applied so as to generate an X-shaped pattern of full adhesive flow, which leaves spaces above and below the center of the X-shape as well as spaces to the lateral left and right of the center of the X-shape. To finish the hourglass-shaped pattern, the spaces above and below the center of the X-shape are filled with zones of reduced adhesive flow 302 while the spaces to the lateral left and right of the X-shape center are not filled with any adhesive, e.g., by zones of no adhesive flow 304. Consequently, it will be understood that various two-dimensional patterns having a resolution of about 25 millimeters can be formed by using the control unit 50 of the applicator 10 to dispense the full volume flow, the reduced volume flow, and no volume flow where necessary on the zones of the substrate.

After the desired pattern of adhesive is discharged onto the substrate via contact or non-contact dispensing (spray being an example of the latter), the substrate is typically adhered to a separate element using the dispensed pattern of adhesive. For example, the zones of full adhesive flow 300 are used to generate strong structural bonds between the substrate and the separate element, while the zones of reduced adhesive flow 302 are used to stabilize the lamination of the substrate. Furthermore, because the liquid dividing modules 12 are located in line with and between the manifold 22 and the dispensing modules 26, the switching between the full volume flow and the reduced volume flow is nearly instantaneous as a result of the dividing control occurring adjacent to and immediately before dispensing at the dispensing modules 26. And unlike conventional systems where volumes are combined downstream of dispensing control valves, the control unit 50 is able to switch each lane of the applicator 10 between dispensing states without needing to account for a significant period of time following the switch of operational modes of the valve devices in which flow from the previous dispensing state is continued. Therefore, the applicator 10 is capable of generating various different desired adhesive deposition patterns defined by zones of full adhesive flow 300, zones of reduced adhesive flow 302, and/or zones of no adhesive flow 304 across substrates of varying widths and lengths without necessitating structural re-assembly and reconfiguration of the applicator 10 and its various modules 12, 26. In this regard, the same applicator 10 may be used for various dispensing operations and product lines of the end user, thereby avoiding the necessity to maintain separate dispensing applicators or systems for each product line.

While the present invention has been illustrated by a description of exemplary embodiments and while these embodiments have been described in some detail, it is not the intention of the Applicants to restrict or in any way limit the scope of the appended claims to such detail. Additional advantages and modifications will readily appear to those skilled in the art. The various features of the invention may be used alone or in any combination depending on the needs and preferences of the user. However, the invention itself should only be defined by the appended claims.

What is claimed is:

1. A variable output dispensing applicator configured to dispense patterns of adhesive onto a substrate, the applicator comprising:
a manifold including a liquid supply passage and a liquid discharge outlet communicating with said liquid supply passage, said manifold delivering a flow of adhesive through said liquid discharge outlet;
a liquid dividing module coupled to said manifold, said liquid dividing module including a liquid inlet communicating with said liquid discharge outlet of said manifold, a liquid outlet, a recirculation passage communicating with said manifold, and internal passages extending between said liquid inlet and said liquid outlet, said liquid dividing module dividing the flow of adhesive from said liquid discharge outlet into a first partial flow of adhesive that continuously moves to said liquid outlet and a second partial flow of adhesive, said liquid dividing module also controlling the second partial flow to selectively provide full volume flow to said liquid outlet in a first operating state and to selectively provide reduced volume flow to said liquid outlet in a second operating state, said liquid dividing module further including a valve member configured to selectively control the movement of the second partial flow of adhesive to said liquid outlet by moving between an open position enabling communication with said liquid outlet and a closed position enabling communication with said recirculation passage; and
a dispensing module coupled to said liquid dividing module to receive flow of adhesive from said liquid outlet, said dispensing module including a dispenser outlet and a dispenser valve member selectively enabling and disabling flow from said liquid dividing module to said dispenser outlet.

2. The applicator of claim 1, said dispensing module further including a second recirculation passage receiving flow of adhesive from said liquid outlet when said dispenser valve member disables flow to said dispenser outlet, and said second recirculation passage is in communication with said manifold via said recirculation passage of said liquid dividing module.

3. The applicator of claim 1, said recirculation passage sized to control a percentage drop in flow between said liquid inlet and said liquid outlet when said valve member closes to provide the reduced volume flow instead of the full volume flow to said liquid outlet.

4. The applicator of claim 1, said internal passages of said liquid dividing module further comprising:
a valve chamber communicating with said recirculation passage and housing said valve member therein;
a first internal passage extending directly from said liquid inlet to said liquid outlet, such that the first partial flow of adhesive flows to said liquid outlet without flowing through said valve chamber; and
a second internal passage extending from said liquid inlet to said valve chamber, and from said valve chamber to said liquid outlet, such that said valve member closes to block a flow through said second internal passage and thereby direct the flow in said second internal passage to said recirculation passage instead of said liquid outlet.

5. The applicator of claim 1, said manifold including a plurality of liquid discharge outlets communicating with said liquid supply passage, and said applicator further comprises:
a plurality of liquid dividing modules arranged in side-by-side relation such that each said liquid dividing module communicates with one of said liquid discharge outlets; and
a plurality of dispensing modules arranged in side-by-side relation such that each said dispensing module communicates with a corresponding one of said liquid dividing modules,
each of said plurality of liquid dividing modules including a liquid outlet and a valve member in the form of an air-actuated spring return valve for controlling the flow to said liquid outlet, and each of said plurality of dispensing modules including a dispenser outlet and a dispenser valve in the form of an air-actuated spring return valve for controlling the flow to said dispenser outlet.

6. The applicator of claim 5, further comprising:
a plurality of air control valves coupled to corresponding ones of said plurality of liquid dividing modules and corresponding ones of said plurality of dispensing modules, said plurality of air control valves controlling actuation air flow for moving said valve members and said dispenser valves; and
a control unit operatively coupled to said plurality of air control valves, said control unit selectively activating said plurality of air control valves to produce output flows of adhesive at said dispensing modules that vary along at least two directions to form the patterns of adhesive on the substrate.

7. A method for dispensing patterns of adhesive onto a substrate with a variable output dispensing applicator including a manifold, a liquid dividing module, and a dispensing module, the method comprising:
delivering a flow of adhesive from the manifold into a liquid inlet of the liquid dividing module;
dividing the flow of adhesive at the liquid dividing module into first and second partial flows of adhesive, the first partial flow of adhesive continuously moving to a liquid outlet of the liquid dividing module for delivery into the dispensing module;
controlling the second partial flow of adhesive to selectively continue flowing to the liquid outlet and into the dispensing module in a first operating state of the liquid dividing module, and to selectively recirculate back to the manifold in a second operating state of the liquid dividing module;
dispensing adhesive received from the liquid outlet at the dispensing module onto the substrate; and
generating a pattern of adhesive having varying amounts of adhesive on the substrate by switching between the first and second operating states of the liquid dividing module during dispensing with the dispensing module, the first operating state providing a full volume flow of adhesive defined by the first and second partial flows of adhesive, and the second operating state providing a reduced volume flow of adhesive defined by only the first partial flow of adhesive.

8. The method of claim 7, wherein the applicator includes a plurality of liquid dividing modules and a plurality of dispensing modules coupled to the manifold, and generating a pattern of adhesive further comprises:
switching between first and second operating states of selected ones of the plurality of liquid dividing modules while the plurality of dispensing modules are operating to dispense adhesive onto the substrate, thereby varying the amounts of adhesive in at least two transverse directions on the substrate into at least first zones coated with the full volume flow of adhesive and second zones coated with the reduced volume flow of adhesive.

9. The method of claim 8, wherein generating a pattern of adhesive includes generating one or more of the following patterns, alone or in combination, on the substrate:
a box-shaped pattern;
an hourglass-shaped pattern;
a striped pattern; and
an X-shaped pattern.

10. The method of claim 7, the liquid dividing module being located between the manifold and the dispensing module such that controlling the second partial flow of the adhesive further comprises:
switching between a full volume flow and a reduced volume flow of adhesive at a location adjacent to and immediately before dispensing of the adhesive at the dispensing module.

11. The method of claim 7, the liquid dividing module including a recirculation passage communicating with the manifold and a valve member, and controlling the second partial flow of the adhesive further comprises:
opening the valve member to enable communication of the second partial flow of adhesive between the liquid inlet and the liquid outlet of the liquid dividing module; and
closing the valve member to divert the second partial flow of adhesive from the liquid inlet to the recirculation passage for return to the manifold.

12. The method of claim 11, the recirculation passage being sized such that when the valve member is closed in the liquid dividing module, the method further comprises:
controlling adhesive flow through the liquid dividing module as a pressure-based system, with the relative amounts of the first and second partial flows of adhesive determined by pressure drops caused by travel through different passages within the liquid dividing module, thereby controlling an amount of volume reduction in flow caused by closing the valve member.

13. The method of claim 7, wherein dispensing adhesive at the dispensing module further comprises:
receiving a process air flow configured to control a discharge of the adhesive from the dispensing module; and
spraying the adhesive using the process air flow to apply the adhesive in a non-contact manner relative to the substrate.

14. The method of claim 7, wherein dispensing adhesive at the dispensing module further comprises:
contact dispensing the adhesive by discharging the adhesive from the dispensing module directly into contact with the substrate.
